(19) United States
(12) Patent Application Publication
(10) Pub. No.: US 2025/0379411 A1
(43) Pub. Date: Dec. 11, 2025

(54) Fiber Laser with Quasi-Pulse-Wave Functionality

(71) Applicant: InnoVoyce LLC, Boston, MA (US)

(72) Inventors: Richard Shaun Welches, Townsend, MA (US); Stephen Neal Mais, Boston, MA (US)

(21) Appl. No.: 19/310,164

(22) Filed: Aug. 26, 2025

Related U.S. Application Data
(63) Continuation-in-part of application No. 18/662,720, filed on May 13, 2024, now Pat. No. 12,431,681.
(60) Provisional application No. 63/604,618, filed on Nov. 30, 2023.

(51) Int. Cl. H01S 3/10; H01S 3/067

(52) U.S. Cl. CPC H01S 3/10038; H01S 3/067

(57) ABSTRACT

The present disclosure relates to a laser device with quasi-pulse-wave (QPW) capabilities. The laser device includes a signal generator, a laser source, and control circuitry. The signal generator is configured to generate a QPW signal for transmission as a laser control signal. The laser source is configured to receive the laser control signal and emit a QPW laser beam responsive thereto. And the control circuitry is configured to receive a user request to operate in a QPW mode, and, responsive to receiving the user request, cause the signal generator to generate the QPW signal. The laser device can also include an optical waveguide configured to emit the laser beam from a second end of the optical waveguide after receiving the laser beam at a first end of the optical waveguide.

### PRIORITY

The present application is a continuation-in-part of U.S. patent application Ser. No. 18/662,720 (filed May 13, 2024), which claims priority to U.S. Provisional App. No. 63/604,618 (filed Nov. 30, 2023). Each of these applications is hereby incorporated by reference in its entirety.

### TECHNICAL FIELD

The present disclosure relates, generally, to laser technologies and, more specifically, to fiber lasers for use in surgery, biomedicine, and other fields.

### BACKGROUND

In recent years, fiber optic lasers have revolutionized surgical procedures, offering unprecedented levels of precision and flexibility. Whereas traditional surgical techniques often required large incisions, fiber lasers allow surgeons to minimize tissue trauma during surgery. Additionally, the flexibility and small size of fiber lasers allow surgeons to access to hard-to-reach areas within the body, expanding the scope of potential surgical interventions.

Notwithstanding the many advancements in this field, there remain opportunities for further improvements to fiber laser technologies. Modern diode lasers, for instance, are not optimized for thermal relaxation time. Thus, surgeries employing these lasers often suffer from excessive thermal spread, tissue charring, and collateral damage.

Additional development to fiber laser technologies promises to further aid surgeons in conducting surgeries therewith, as well as all others that employ fibers lasers in their respective fields.

### SUMMARY

Many surgical procedures require blood vessel coagulation, as well as the cutting or removal of tissue. Tumor treatments, for example, oftentimes involve the selective coagulation of blood vessels feeding a tumor, followed by the ablation or excision of said tumor. These sorts of surgical procedures generally require multiple fiber lasers, one for coagulation and one for ablation or excision.

Surgeries requiring multiple lasers are complicated, especially when the surgery is performed endoscopically or laryngoscopically. Maneuvering the fiber laser to the surgical site takes effort, time, and skill. And this is compounded when the fiber laser must be removed and replaced with another laser mid-surgery because the first laser was specialized for a particular operation (e.g., coagulation) and the second laser is needed for another (e.g., ablation). The optical waveguide coupled to the fiber laser is oftentimes sterile and intended only for single use. Accordingly, laser swaps generally also require replacing the optical waveguide, as well.

An ideal fiber laser would be capable of operating in different modes, allowing it to handle each or at least multiple of the laser-driven operations in a given surgical procedure. Such a laser would not only simplify surgery, but it would reduce waste, expedite the procedure, and keep costs down, as well. The present disclosure provides such a laser, with various innovations that allow fiber lasers to operate with increased versatility. The subject technology allows a surgeon, for instance, to selectively coagulate blood vessels and then to ablate tissue with a single fiber laser apparatus. The fiber laser may accomplish this by surgeon-driven selection of a first operating mode for coagulation (e.g., characterized by short pulse duration) and a second operating mode for tissue ablation (e.g., characterized by longer pulse duration or continuous waves).

The various modes discussed herein include quasi-pulsed-wave (QPW) mode, pulsed-wave (PW) mode, quasi-continuous-wave (QCW) mode, and continuous-wave (CW) mode. Of these, QPW mode can be a particularly advantageous lasing mode which, in some embodiments, bridges the gap between traditional CW diode lasers and PW lasers (e.g., potassium titanyl phosphate, or KTP, lasers). In some embodiments, QPW mode involves modulating a diode laser output to deliver energy in short, controllable bursts with adjustable pulse durations and controlled off-times. Whereas traditional diode laser pulses consist of continuous on-times with minimal off-time, QPW pulses incorporate structured intervals that allow for partial tissue cooling (via thermal diffusion) between bursts. This can allow embodiments of the present disclosure to yield reduced tissue charring, less thermal spread, and/or a cleaner surgical effect while maintaining the advantages of diode laser systems (incl. size, cost, efficiency).

Additionally, QPW mode can be particularly useful for aggressively absorbed wavelengths, especially when the laser is manually delivered via fiber or waveguide. Laser handpieces often include a distance gauge to place focusing optics at a controlled distance from the target. This accounts for diverging or converging beams which change spot size and thus irradiance or fluence at the target. Often unintended user tilt of a handpiece results in uneven target surface area fluence since one side of the laser spot is farther from the intended focal plane and the other side is nearer than intended. For a diverging beam and an aggressively absorbed wavelength, the nearer side of the laser spot would be overtreated and the far side of the spot would be undertreated. This results in “fish scale” treated spot with fish scale shaped burns tiled on the target surface. So, another benefit of QPW mode is that it compensates for tilt (read: misuse) of laser outputs, which rely on a mechanical distance gauge to maintain target surface fluence within an acceptable working distance when exposed to handpiece tilt-type misuse.

### Example Embodiments Include the Following:

A Laser Device. The laser device includes a signal generator, a laser source, and control circuitry. The signal generator is configured to generate a QPW signal for transmission as a laser control signal. The laser source is configured to receive the laser control signal and emit a QPW laser beam responsive thereto. And the control circuitry is configured to receive a user request to operate in a QPW mode, and, responsive to receiving the user request, cause the signal generator to generate the QPW signal. An optical waveguide associated with the laser device is configured to emit the laser beam from a second end of the optical waveguide after receiving the laser beam at a first end of the optical waveguide.

A Non-Transitory, Computer-Readable Medium. The medium includes instructions that, when executed by a processor of an electronic device that includes a signal generator and a laser source, cause the processor to perform operations. The operations include receiving a user request to operate in a requested mode including a QPW mode. The operations also include, responsive to receiving the user request, causing the signal generator to generate a laser control signal in accordance with the requested mode. The signal generator is configured to separately generate one or more signals for transmission as a laser control signal, where the one or more signals include a QPW signal. Additionally, the laser source is configured to receive the laser control signal and emit a QPW laser beam responsive to receiving the laser control signal. Further, an optical waveguide is configured to emit the laser beam from a second end of the optical waveguide after receiving the laser beam at a first end of the optical waveguide.

A Method of Performing Laser Surgery. The method includes causing a laser device to emit a QPW laser beam. The method also includes, while the laser device is emitting the QPW laser beam, simultaneously directing the laser device toward target tissue and positioning the laser device within a region of clinical effectiveness determined at least in part by a peak-power setting of the laser device.

Other configurations of the subject technology will be apparent to those skilled in the art from the detailed description below, which describes various configurations of the subject technology and illustrations thereof. The subject technology is capable of other and different configurations, and its several details are capable of modification in various other respects, all without departing from the scope of the subject technology. Thus, the Drawings and Detailed Description are presented as illustrative in nature and should not be construed as restricting the present disclosure.

### BRIEF DESCRIPTION OF THE DRAWINGS

For a better understanding of the present disclosure, reference should be made to the Detailed Description, below, in conjunction with the following drawings. Like reference numerals refer to corresponding parts throughout the figures and the description.

FIGS. 1A and 1B illustrate example components of laser devices, according to various aspects of the subject technology.

FIGS. 2A to 2D illustrate example laser beams emitted by a laser device, according to various aspects of the subject technology.

FIG. 3 illustrates an example process for operation of a laser device configured to operate in multiple different modes, according to various aspects of the subject technology.

FIGS. 4A and 4B illustrate first and second waveforms associated with pulsed and quasi-pulsed operation, respectively, according to various aspects of the subject technology.

FIG. 5 illustrates a graphical user interface (GUI) for a laser device, according to various aspects of the subject technology.

FIG. 6 illustrates regions of clinical effectiveness associated with pulsed and quasi-pulsed operation, respectively, according to various aspects of the subject technology.

FIGS. 7A to 7D are line plots that illustrate power or energy per unit area as a function of distance between a fiber optic tip and target tissue, according to various aspects of the subject technology.

FIG. 8 illustrates a blood vessel being heated by thermal diffusion, according to various aspects of the subject technology.

### DETAILED DESCRIPTION

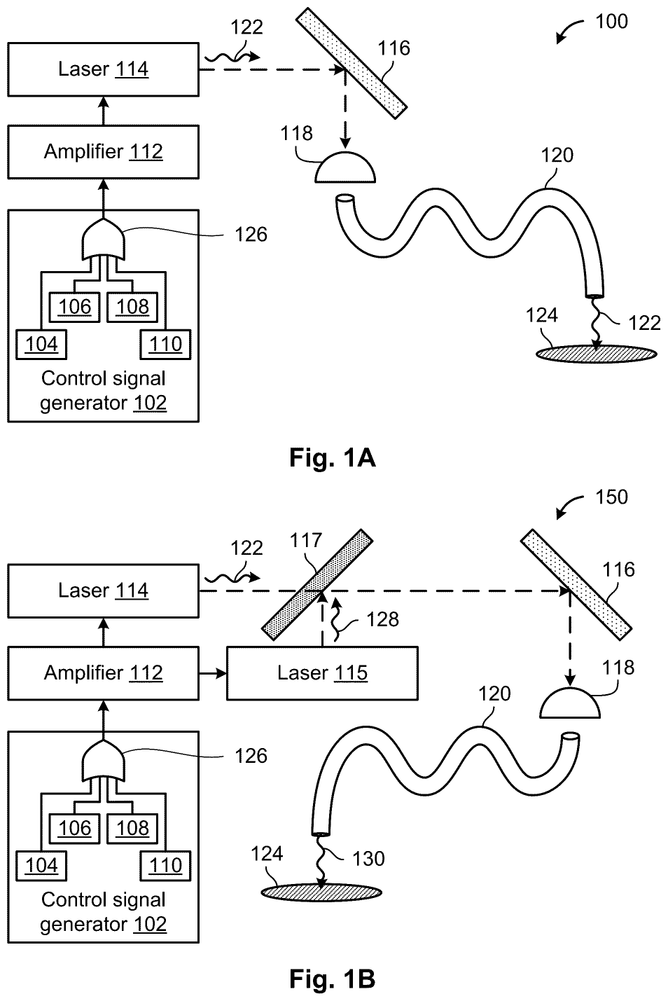

FIGS. 1A and 1B illustrate example components of laser devices 100 and 150, according to various aspects of the subject technology. Specifically, FIG. 1A illustrates a first laser device 100 configured to focus a laser beam 122 into a first end of an optical waveguide 120, whereafter the optical waveguide 120 emits the laser beam 122 towards a target arca 124.

In the illustrated embodiment, the laser device 100 includes a control signal generator 102 with a PW signal generator 104, a QPW signal generator 106, a CW signal generator 108, and a QCW signal generator 110. In some embodiments, control signal generator 102 includes only two or three of the individual signal generators 104, 106, 108, and/or 110. Depending on the current operating mode of the laser device 100, the control signal generator 102 is configured to generate—for transmission as a laser control signal—a PW signal using the PW signal generator 104, a QPW signal using the QPW signal generator 106, a CW signal using the CW signal generator 108, or a QCW signal using the QCW signal generator 110. As illustrated, in some embodiments, the control signal generator 102 also includes logical circuitry 126 (e.g., an OR gate) for synthesizing signals generated by the various individual signal generators 104, 106, 108, and 110 into the laser control signal.

The laser device 100 also includes an amplifier 112 and a laser 114. These two components of the laser device 100 cooperate to receive the control signal from the laser control signal generator 102 and produce a laser beam 122 responsive to receiving the laser control signal and in accordance with the laser control signal. Specifically, the laser 114 is configured to emit a PW laser beam if the laser control signal includes the PW signal, a QPW laser beam for the QPW signal, a CW laser beam for the CW signal, or a QCW laser beam for the QCW signal.

Additionally, the laser device 100 includes a turning mirror 116 and a lens 118. The turning mirror 116 is configured to reflect the laser beam 122 and the lens 118 is configured to focus the laser beam 122. The turning mirror 116 is positioned relative to the laser 114, the lens 118, and a first end (i.e., nearest the lens 118) of the optical waveguide 120 such that the laser beam 122 is received at the first end of the optical waveguide 120 after the laser beam 122 is reflected off the turning mirror 116 and then focused by the lens 118. After the laser beam 122 is received at the first end of the optical waveguide 120, the laser beam 122 is emitted from the second end (i.e., furthest from the lens 118) of the optical waveguide 120 towards a target arca 124, such as a surgical site.

The laser device 100 can be operated to achieve blood-vessel-absorption selectivity with the laser beam 122 having a wavelength of approximately 455 nanometers (e.g., ±10 nm). This wavelength has sufficiently high hemoglobin and blood absorption, as well as sufficiently low wavelength absorption in untargeted tissue chromophores, such as water. Another advantage of the 455 nanometer wavelength is the relative transparency of water (i.e., low absorption), which allows laser irradiation to pass through water-rich tissue (e.g., mucosal layers) and be absorbed by hemoglobin-rich chromophores (e.g., below mucosal layers). In this manner, the laser device 100 can achieve selective heating of hemoglobin-rich areas while minimizing heating of intervening mucosa and other layers.

Additionally, the laser device 100 can be operated to achieve temporal selectivity with pulsed-or QPW modes. While operating in these modes, the pulse width of the laser beam 122 may range from approximately 200 microseconds (e.g., ±10 μs) to approximately 200 milliseconds (e.g., ±10 ms), with a power output of roughly 20 watts (e.g., ±10 W) peak. These settings should be sufficient to raise the temperature of the target area 124 sufficiently for coagulation or involution while also providing requisite hemostasis. Where selective vessel coagulation or involution is delivered by means of pulse durations with thermal time constants less than that of the target area 124, the QPW mode may allow for selective targeting of small vessels even when the vessels are adjacent to or below other un-targeted vessels.

Further, in some embodiments, a robust cut and ablation capability is provided with a laser beam 122 having a wavelength of approximately 455 nanometers (e.g., ±10 nm) and a power output of roughly 20 watts (e.g., ±10 W) average. This laser beam 122 can be employed in a continuous- or QCW mode, where the latter mode consists of a continuous stream of adjustable duration “micro-pulses” of approximately 200 microseconds (e.g., ±10 μs) to approximately 20 milliseconds (e.g., ±10 ms), with a duty cycle of approximately 10-90% (e.g., ±2%). Pulse durations longer than the thermal time constant of the chromophore-containing tissue or structure can be used such that thermal diffusion from the 455 nanometer absorbing tissue region is intentionally conducted to nearby areas in order to facilitate optimum cutting or ablation.

Moreover, in some embodiments, the optical waveguide 120 is a fiber optic cable, thus providing flexibility in positioning the second end of the optical waveguide 120 with respect to the target area 124. The optical waveguide 120 may thus allow for use via the working channel of either flexible or fixed endoscopes, laryngoscopes, or other scopes, or directly via a handheld fiber. It is noted that the second end of the optical waveguide 120 may, in some embodiments, be coupled to a handpiece with internal focusing optics, via an empty handpiece channel, or via a cannula.

Furthermore, in some embodiments, the laser beam 122 has a wavelength of approximately 455 nanometers (e.g., ±10 nm) and the aforenoted four modes are provided via diode laser drive electronics with an associated control means (e.g., control signal generator 102). The control means can provide pulse duration and pulse pattern timing, thus acting as a control input to the laser drive electronics. The control means may consist of firmware, hardware and software elements and may allow for user adjustment or fine tuning of laser operating parameters.

Turning now to FIG. 1B, the second laser device 150 also includes a control signal generator 102 with a PW signal generator 104, a QPW signal generator 106, a CW signal generator 108, a QCW signal generator 110, and logical circuitry 126. The second laser device 150 also includes an amplifier 112 and a laser 114, as well as a turning mirror 116 and a lens 118.

However, unlike the first laser device 100, the second laser device 150 includes a second laser 115 and a selective turning mirror 117. In cooperation with the amplifier 112, the second laser 115 is configured to receive the laser control signal from the control signal generator 102 and emit another laser beam 128 responsive to receiving the laser control signal and in accordance with the laser control signal. Similar to the first laser 114, the second laser 115 is configured to emit a PW laser beam if the laser control signal includes the PW signal, a QPW laser beam for the QPW signal, a CW laser beam for the CW signal, or a QCW laser beam for the QCW signal.

The selective turning mirror 117 is configured to reflect the second laser beam 128 but transmit the first laser beam 122. In the illustrated embodiment, the turning mirror 116 and the selective turning mirror 117 are positioned relative to the first laser 114, the lens 118, and the first end of the optical waveguide 120 such that the first laser beam 122 is received at the first end of the optical waveguide 120 after the first laser beam 122 is transmitted through the selective turning mirror 117, then reflected off the turning mirror 116, and finally focused by the lens 118. Additionally, in the illustrated embodiment, the turning mirror 116 and the selective turning mirror 117 are positioned relative to the second laser 115, the lens 118, and the first end of the optical waveguide 120 such that the second laser beam 128 is received at the first end of the optical waveguide 120 after the second laser beam 128 is reflected off the selective turning mirror 117, then reflected off the turning mirror 116, and finally focused by the lens 118.

After the first laser beam 122 is received at the first end of the optical waveguide 120, the first laser beam 122 is emitted from the second end of the optical waveguide 120 towards a target area 124, such as a surgical site. Likewise, after the second laser beam 128 is received at the first end of the optical waveguide 120, the second laser beam 128 is emitted from the second end of the optical waveguide towards the target area 124. In some embodiments, the first and second lasers 114-115 are configured to alternate operation such that the optical waveguide emits either the first laser beam 122 or the second laser beam 128. First and second lasers 114-115 may be selected to emit at different predetermined wavelengths. In some embodiments, first laser 114 is configured to emit a laser beam (first laser beam 122) having wavelength that is shorter than the laser beam (second laser beam 128) emitted by second laser 115. In some embodiments, first laser 114 is configured to emit at a wavelength in the visible light spectrum (e.g., 380 nm to 750 nm) while second laser 115 is configured to emit at a wavelength in the near-infrared spectrum (e.g., 750 nm to 3000 nm). In some embodiments, first laser 114 emits at a predetermined wavelength selected to treat a first tissue type (e.g., blood vessels or other soft tissue) and second laser 115 emits a predetermined wavelength selected to treat a second tissue type that is different than the first tissue type (e.g., bone). In some such embodiments, a single laser device 100 may be configured to treat a variety of different tissues.

In some embodiments, the first and second lasers 114-115 are configured to operate in rapid succession (e.g., within less than 10 ms of each other), such that the first laser 114 operates for a short amount of time (e.g., 10 ms), followed by operation of the second laser 115 for another short amount of time (e.g., 10 ms), again followed by the first laser 114, and so on. In some embodiments, when operating in rapid succession, the first laser beam 122 has a first wavelength of roughly 455 or 532 nanometers (e.g., ±10 nm), and the second laser beam 128 has a second wavelength of roughly 1064 nanometers (e.g., ±10 nm). The amount of time between operation of the first and second lasers 114-115 may range from 10 to 100 milliseconds depending, for instance, on the importance of delivering the first and second lasers in tight sequence with one another.

In some embodiments, the first and second lasers 114-115 are used independently of each other (e.g., using the same optical waveguide 120 but not within quick succession of each other). For example, the first laser 114 can be used for a first amount of time (e.g., 1 min) and the second laser can then be used for a second amount of time (e.g., 2 min). In some embodiments, the first laser 114 is configured to emit a laser beam 122 with a wavelength of approximately 455 nanometers (e.g., ±20 nm) or approximately 532 nanometers (e.g., ±30 nm) for blood vessels, cartilage, or soft tissue, while the second laser 115 is configured to emit a laser beam 128 with an erbium, near-infrared wavelength (e.g., 2,780±10 nm, 2,940±10 nm, or any other wavelength between 2,650-3,000 nm) for bone or tissues with hydroxyapatite. In this manner, the two lasers 114-115 can greatly expand the clinical applications of the present technology.

In some of these embodiments, the first laser 114 operates in a first operating mode including one of a PW mode, a QPW mode, a CW mode, or a QCW mode, and the second laser operates in a second operating mode including one of a PW mode, a QPW mode, a CW mode, or a QCW beam. In some embodiments, the first and second modes are different modes; however, in some embodiments, the first and second modes are the same mode. These modes can be selected by a user and may further improve the capacity of the laser device 100 for cutting, coagulating, or otherwise affecting tissue, bone, or other organic material (e.g., without the need for replacing the optical waveguide 120 for another optical waveguide).

In some embodiments, the optical waveguide 120 is a single hollow core waveguide suitable for CO₂ lasers having approximately 10,600 nanometer (e.g., ±100 nm) wavelengths. In some of these embodiments, the first laser beam 122 has a wavelength of 455 or 532 nanometers (e.g., for soft tissue) and the second laser beam 128 has a wavelength of 10,600 nanometers (e.g., for bone), and the optical waveguide 120 is configured such that it can be used to deliver both of the laser beams 122 and 128 (e.g., in succession or simultaneously).

However, in some embodiments, the first and second lasers 114-115 operate concurrently such that both of the laser beams 122 and 128 are simultaneously received at the first end of the optical waveguide as a multiplexed laser beam 130. This multiplexed laser beam 130 is emitted from the second end of the optical waveguide 120 after being received at the first end thereof. In this manner, the second laser device 150 is able to operate in a variety of modes in addition to the four modes discussed above with respect to the first and second laser devices 100 and 150. In particular, the second laser device can further modulate its operation by selectively enabling its lasers 114-115.

In some instances, it is advantageous to apply more than one or a multiplicity of distinct wavelengths down the same optical fiber to the treated region. This may be beneficial for example when a first wavelength acts to heat a target for the purpose of altering the targets' absorption characteristics to more greatly absorb a second wavelength. This is particularly advantageous where the second wavelength may therefore penetrate more deeply into the targeted arca 124.

One example of this includes 455 nanometers as a first wavelength (e.g., of the first laser 122), which acts to heat oxy-hemoglobin and thereby produce met-hemoglobin—so as to increase absorption of a second wavelength (e.g., of the second laser 128), such as 1064 nanometers. This combined, multiplexed laser beam 130 may coagulate blood vessels, which are deeper than could be otherwise coagulated. Or the multiplexed laser beam 130 may result in coagulation of blood vessels at shallower depths with reduced energy or laser power than would be otherwise possible. This multi-wavelength approach is subject to many variations and many wavelength alternatives, although generally the first wavelength is selected to alter the targeted tissue or structures' chromophores to more readily absorb a second wavelength.

In order to ensure reliable predictable hemostasis, it may sometimes be necessary to first coagulate or involute very small vessels occupying a shallower depth over deeper and larger vessels and thereafter to coagulate or involute the deeper vessels with a longer pulse duration. The shallower smaller vessels being treated with shorter duration pulses in this example would be immediately followed by longer duration pulses sufficient to coagulate or involute the larger vessels.

Another method of coagulating various vessels at various depths may involve using a first wavelength and first pulse duration for shallower vessels immediately followed by a second wavelength with a second pulse duration. For example, the first wavelength and pulse duration could target shallow, small vessels by means of short pulse durations to confine damage to the targeted vessels. These short pulses may use a highly absorbed but shallow penetrating wavelength, such as 455 nanometers. The second wavelength and longer pulse duration, then, could coagulate or involute deeper vessels or structures by means of longer pulse durations with a deeper penetrating wavelength, such as 1064 nanometers. Likewise, larger shallow vessels would only require a longer pulse duration of, for example, 455 nanometers and where smaller and deeper vessels may be targeted by means of shorter duration pulse of 1064 nanometers.

This approach is not restricted to targeting blood vessels. In some embodiments, the approach is used for other biological targets, with wavelengths selected on the basis of one or more of penetration depth or the absorption by native chromophores within or upon the desired targets. In some cases, artificial or externally derived dyes may be applied to desired targets to boost laser absorption and thereby extend the targetable depth or reduce the laser energy or power required to effectively treat the desired target.

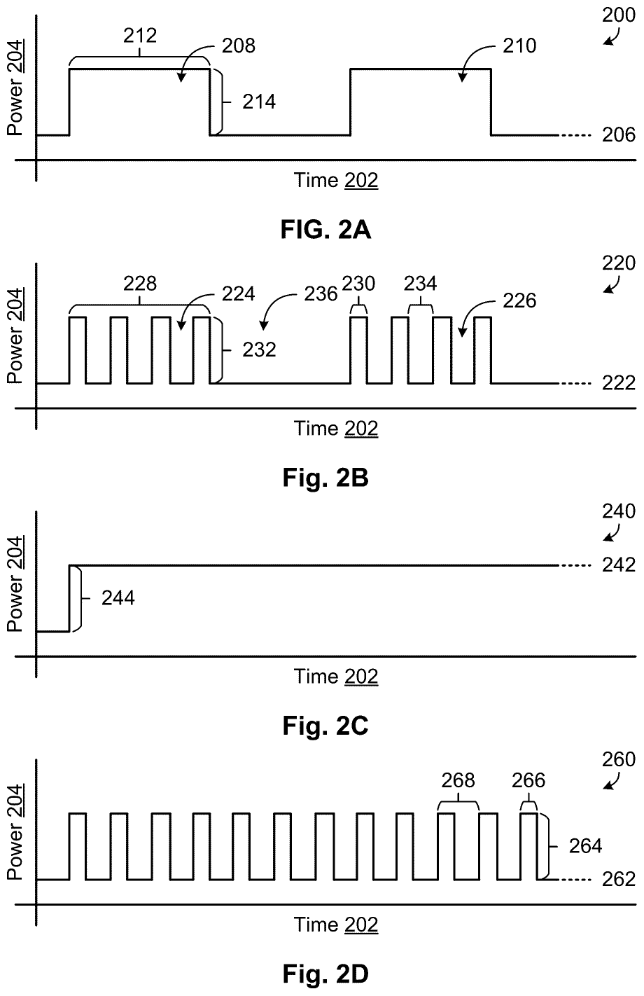

FIGS. 2A through 2D illustrate example laser beams 206, 222, 242, and 262 emitted by a laser device (e.g., laser device 100 or 150), according to various aspects of the subject technology. Each of the laser beams 206, 222, 242, and 262 is illustrated on a graph chart 200, 220, 240, or 260 with respective x- and y-axes 202 and 204 corresponding, respectively, to time and the power output of the laser beam.

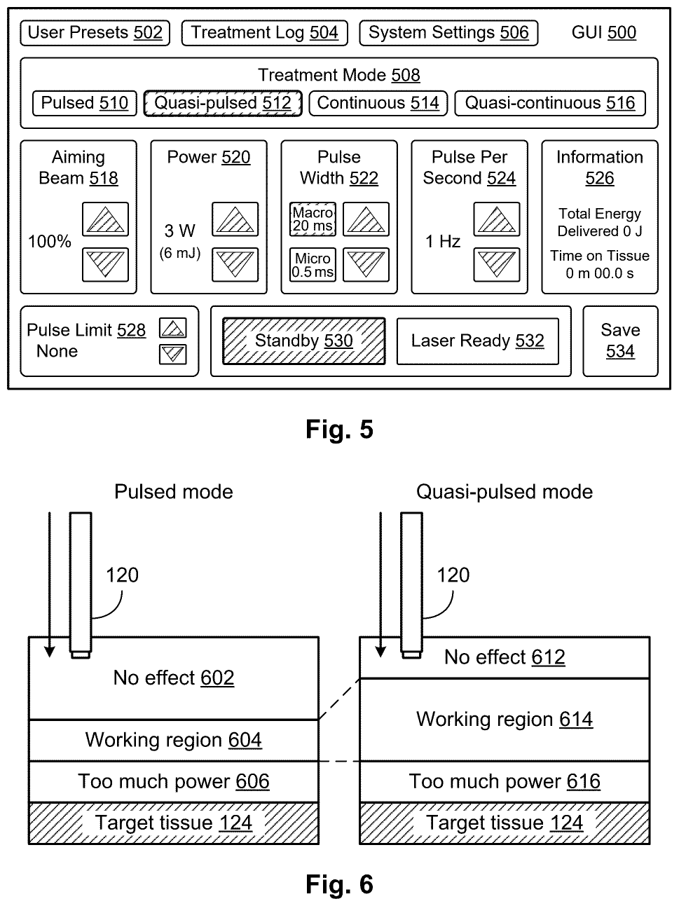

The first laser beam 206 is a PW laser beam characterized by pulses 208 and 210, each of which has a width 212 and an amplitude 214. The second laser beam 222 is a QPW laser beam characterized by pulses 224 and 226, each of which has a width 228 (or macro-width) and an amplitude 232. Unlike the pulses 208 and 210 of the first laser beam 206, however, each of the pulses 224 and 226 of the second laser beam 222 involve oscillations (“micro-pulses”) with respective sub-widths 230 (or micro-widths). In some embodiments, the macro-width 228 and/or the micro-width 230 of the QPW laser beam is set by a user (see, e.g., GUI 500 of FIG. 5).

In some embodiments, each of pulses 224 and 226 comprise two or more micro-pulses within the macro-width 228, e.g., two, three, four, five, or six micro-pulses. The micro-pulses of a pulse are separated by an off-time (where the laser beam 222 is not emitted), such as off-time 234 between the second and third micro-pulses of the second macro-pulse 226. In some embodiments, pulses 224 and 226 are separated by an off-time (where the laser beam 222 is not emitted) that is greater than the off-time between sequential micro-pulses of a pulse, such as off-time 236 between the macro-pulses 224 and 226.

In some embodiments, the micro-width 230 of the QPW laser beam 222 is selected to be, for example, less than 5 milliseconds, less than 4.5 milliseconds, less than 4 milliseconds, less than 3.5 milliseconds, less than 3.0 milliseconds, less than 2.5 milliseconds, less than 2.0 milliseconds, less than 1.5 milliseconds, or less than 1.0 milliseconds. In some embodiments, the micro-width 230 of the QPW laser beam 222 is selected to be at least 0.5 milliseconds. In some embodiments, the micro-width 230 of the QPW laser beam 222 is within a range from about 0.5 milliseconds to about 4.5 milliseconds, about 0.6 milliseconds to about 4.4 milliseconds, about 0.7 milliseconds to about 4.3 milliseconds, about 0.8 milliseconds to about 4.2 milliseconds, about 0.9 milliseconds to about 4.1 milliseconds, about 1.0 milliseconds to about 4.0 milliseconds, about 1.1 milliseconds to about 3.9 milliseconds, about 1.2 milliseconds to about 3.8 milliseconds, about 1.3 milliseconds to about 3.7 milliseconds, about 1.4 milliseconds to about 3.6 milliseconds, about 1.5 milliseconds to about 3.5 milliseconds, about 1.6 milliseconds to about 3.4 milliseconds, about 1.7 milliseconds to about 3.3 milliseconds, about 1.8 milliseconds to about 3.2 milliseconds, about 1.9 milliseconds to about 3.1 milliseconds, about 2.0 milliseconds to about 3.0 milliseconds, about 2.1 milliseconds to about 2.9 milliseconds, about 2.2 milliseconds to about 2.8 milliseconds, about 2.3 milliseconds to about 2.7 milliseconds, or about 2.4 milliseconds to about 2.6 milliseconds. In some embodiments, the micro-width 230 of the QPW laser beam 222 is within a range from about 1.0 milliseconds to about 3.0 milliseconds, about 1.1 milliseconds to about 2.9 milliseconds, about 1.2 milliseconds to about 2.8 milliseconds, about 1.3 milliseconds to about 2.7 milliseconds, about 1.4 milliseconds to about 2.6 milliseconds, about 1.5 milliseconds to about 2.5 milliseconds, about 1.6 milliseconds to about 2.4 milliseconds, about 1.7 milliseconds to about 2.3 milliseconds, about 1.8 milliseconds to about 2.1 milliseconds, or about 1.9 milliseconds to about 2.0 milliseconds.

In some embodiments, the macro-width 228 of the QPW laser beam 222 is at least 10 milliseconds. In some embodiments, the macro-width 228 of the QPW laser beam 222 may within a range from about 10 milliseconds to about 30 milliseconds, including about 11 milliseconds to about 29 milliseconds, about 12 milliseconds to about 28 milliseconds, about 13 milliseconds to about 27 milliseconds, about 14 milliseconds to about 26 milliseconds, about 15 milliseconds to 25 milliseconds, about 16 milliseconds to about 24 milliseconds, about 17 milliseconds to about 23 milliseconds, about 18 milliseconds to 22 milliseconds, or about 19 milliseconds to about 21 milliseconds.

In some embodiments, the off-time between sequential micro-pulses in a pulse may be less than 5 milliseconds. In some embodiments, the off-time between sequential micro-pulses in a pulse may be at least 0.5 milliseconds. In some embodiments, the off-time between sequential micro-pulses of a pulse is within a range from about 0.5 milliseconds to about 4.5 milliseconds, about 0.6 milliseconds to about 4.4 milliseconds, about 0.7 milliseconds to about 4.3 milliseconds, about 0.8 milliseconds to about 4.2 milliseconds, about 0.9 milliseconds to about 4.1 milliseconds, about 1.0 milliseconds to about 4.0 milliseconds, about 1.1 milliseconds to about 3.9 milliseconds, about 1.2 milliseconds to about 3.8 milliseconds, about 1.3 milliseconds to about 3.7 milliseconds, about 1.4 milliseconds to about 3.6 milliseconds, about 1.5 milliseconds to about 3.5 milliseconds, about 1.6 milliseconds to about 3.4 milliseconds, about 1.7 milliseconds to about 3.3 milliseconds, about 1.8 milliseconds to about 3.2 milliseconds, about 1.9 milliseconds to about 3.1 milliseconds, about 2.0 milliseconds to about 3.0 milliseconds, about 2.1 milliseconds to about 2.9 milliseconds, about 2.2 milliseconds to about 2.8 milliseconds, about 2.3 milliseconds to about 2.7 milliseconds, or about 2.4 milliseconds to about 2.6 milliseconds.

In some embodiments, the sum of micro-width 230 and the off-time between sequential micro-pulses in a pulse is a predetermined amount, for example, within a range from about 4.0 milliseconds to about 6.0 milliseconds, about 4.1 milliseconds to about 5.9 milliseconds, about 4.2 milliseconds to about 5.8 milliseconds, about 4.3 milliseconds to about 5.7 milliseconds. about 4.4 milliseconds to about 5.6 milliseconds, about 4.5 milliseconds to about 5.5 milliseconds, about 4.6 milliseconds to about 5.4 milliseconds, about 4.7 milliseconds to about 5.3 milliseconds, about 4.8 milliseconds to about 5.2 milliseconds, or about 4.9 milliseconds to about 5.1 milliseconds. In some embodiments, the sum of micro-width 230 and the off-time between sequential micro-pulses in a pulse is or about 5.0 milliseconds.

The third laser beam 242 is a CW laser beam characterized by a continuous pulse with an amplitude 244. Finally, the fourth laser beam 262 is a QCW laser beam characterized by an oscillating pulse with an amplitude 264 and a wavelength 268 and a sub-width 266 for each individual oscillation.

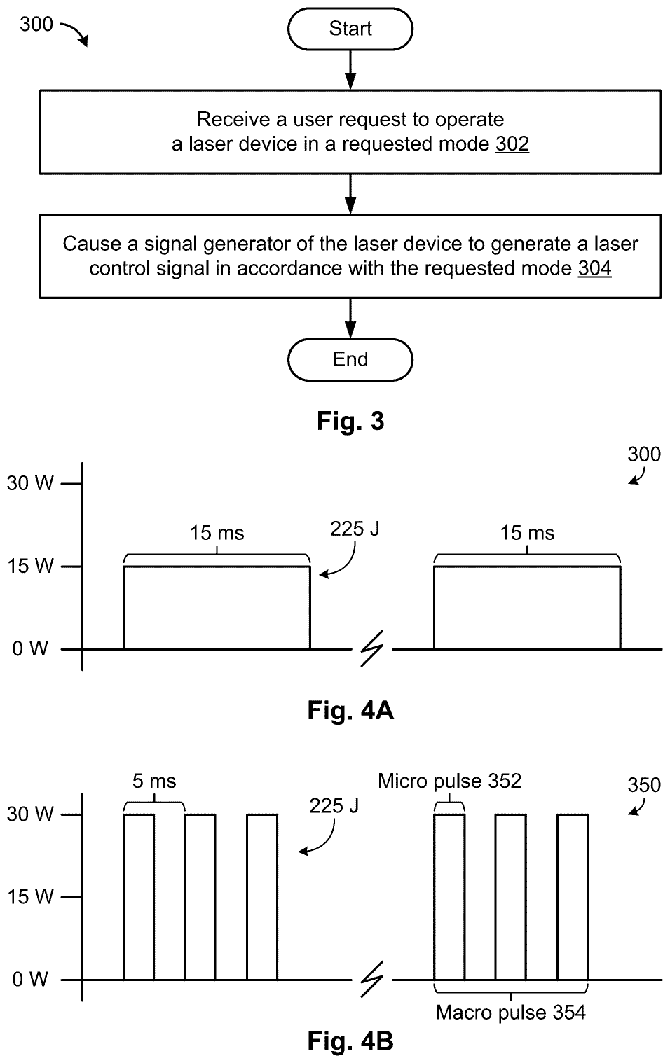

FIG. 3 illustrates an example process 300 for operation of a laser device (e.g., laser device 100 or laser device 150) configured to operate in multiple different modes, according to various aspects of the subject technology. The operations of process 300 can be carried out by hardware, such as that discussed above with respect to FIGS. 1A through 2D, including the control signal generator 102 of FIGS. 1A and 1B. Additionally, the process 300 can also be executed by a processor configured to execute instructions stored in a non-transitory, computer-readable medium.

In the illustrated embodiment, the process 300 includes receiving (302) a user request to operate a laser device (e.g., laser device 100 or 150) in a requested mode, where the requested mode is either a PW mode, a QPW mode, a CW mode, or a QCW mode.

The process also includes causing (304) a signal generator (e.g., control signal generator 102) of the laser device to generate a laser control signal in accordance with the requested mode. The signal generator is configured to separately generate two or more of a PW signal (e.g., using PW signal generator 104), a QPW signal (e.g., using QPW signal generator 106), a CW signal (e.g., using CW signal generator 108), and a QCW signal (e.g., using QCW signal generator 110) for transmission as a laser control signal.

The laser control signal is transmitted to a laser source (e.g., laser 114) of the laser device. The laser source is configured to receive the laser control signal and emit a laser beam (e.g., laser beam 122) responsive to receiving the laser control signal and in accordance with the laser control signal. The laser beam is either a PW laser beam (e.g., PW laser beam 206), a QPW laser beam (e.g., QPW laser beam 222), a CW laser beam (e.g., CW laser beam 242), or a QCW laser beam (e.g., QCW laser beam 262). Additionally, an optical waveguide (e.g., optical waveguide 120) is configured to emit the laser beam from a second end of the optical waveguide (e.g., furthest from lens 118) after receiving the laser beam at a first end of the optical waveguide (e.g., nearest lens 118).

In some embodiments, the method further includes, after causing the signal generator to generate the laser control signal in accordance with the requested mode receiving another user request to operate in another requested mode and, responsive to receiving the other user request, causing the signal generator to generate the laser control signal in accordance with the other requested mode. Like the aforenoted requested mode, the other requested mode is either the PW mode, the QPW mode, the CW mode, or the QCW mode. The other laser control signal is transmitted to the laser source.

In some embodiments, the laser device further includes another laser source (e.g., laser 115) configured to receive the laser control signal and emit another laser beam (e.g., laser beam 128) responsive to receiving the laser control signal and in accordance with the laser control signal. Like the aforenoted laser beam, the other laser beam is either a PW laser beam, a QPW laser beam, a CW laser beam, or a QCW laser beam. The optical waveguide is further configured to emit a multiplexed laser beam (e.g., multiplexed laser beam 130) from the second end of the optical waveguide responsive to receiving the multiplexed laser beam at the first end of the optical waveguide. The multiplexed laser beam includes the laser beam and the other laser beam.

In some embodiments, the laser device further includes a selective turning mirror (e.g., selective turning mirror 117) and a turning mirror (e.g., turning mirror 116). The selective turning mirror is configured to transmit the laser beam and reflect the other laser beam. Additionally, the turning mirror is configured to reflect the laser beam and reflect the other laser beam. Further, the selective turning mirror and the turning mirror are positioned relative to the laser source, the other laser source, and the first end of the optical waveguide such that the laser beam is received at the first end of the optical waveguide after the laser beam is transmitted through the selective turning mirror and then reflected off the turning mirror, the other laser beam is received at the first end of the optical waveguide after the laser beam is reflected off the selective turning mirror and then reflected off the turning mirror, and the laser beam and the other laser beam are concurrently received at the first end of the optical waveguide as the multiplexed laser beam.

In some embodiments, the laser device further includes a focusing lens (e.g., lens 118) configured to focus the multiplexed laser beam. The focusing lens is positioned relative to the first end of the optical waveguide such that the multiplexed laser beam is focused by the focusing lens before the multiplexed laser beam is received at the first end of the optical waveguide.

In some embodiments, while the laser source and/or the other laser source is operating in a mode where the laser beam and/or the other laser beam has a wavelength (e.g., QCW mode), the laser beam has a wavelength between 450-460 nanometers and/or the other laser beam has a wavelength between 1060-1070 nanometers.

In some embodiments, while the laser source and/or the other laser source is operating in a mode where the laser beam and/or the other laser beam has a pulse duration (e.g., PW mode, QPW mode), the laser beam has a pulse duration between 500-50,000 microseconds and/or the other laser beam has a pulse duration between 500-50,000 microseconds.

In some embodiments, the laser beam has a power output between 10-30 watts and/or the other laser beam has a power output between 10-80 watts.

In some embodiments, the laser device further includes a radiofrequency identification (RFID) reader configured to read from and write to an RFID tag embedded within the optical waveguide, where the RFID tag includes a unique identifier associated with the optical waveguide. Additionally, the method further includes causing the RFID reader to read the unique identifier from the RFID tag. Further, the method includes identifying the optical waveguide based on the unique identifier. Moreover, the method includes writing a use identifier to the RFID tag, wherein the use identifier indicates that the optical waveguide has been used in a surgical procedure.

In some embodiments, the laser device includes an RFID-based means for reading and writing to optical waveguides with an RFID tag such that the optical waveguide, once used, is thereafter disabled to prevent reuse. For example, the method may further include causing the RFID reader to read the use identifier from the RFID tag, determining that the optical waveguide has been used in a surgical procedure based on the use identifier, and rejecting the optical waveguide responsive to determining that the optical waveguide has been used in a surgical procedure.

FIGS. 4A to 8 are of particular relevance to QPW operation according to some embodiments, though some of these figures also shed further light on PW, QCW, and CW operation, as well. In some embodiments, a laser device (e.g., laser device 100, 150) can be operated in a QCW mode to emit laser energy in a series of micro-pulses that make up a macro-pulse (sec FIGS. 2B, 4A, 4B). During such operation, in some embodiments, the user can select the energy per pulse and duty cycle, for instance, based on tissue type or a desired clinical outcome (see FIG. 5). Similarly, in some embodiments, the user can adjust the off-time (duty cycle) to align with a thermal relaxation time of the target tissue, ensuring that the temperature does not build excessively between pulses—thereby reducing char and thermal damage (see FIG. 5).

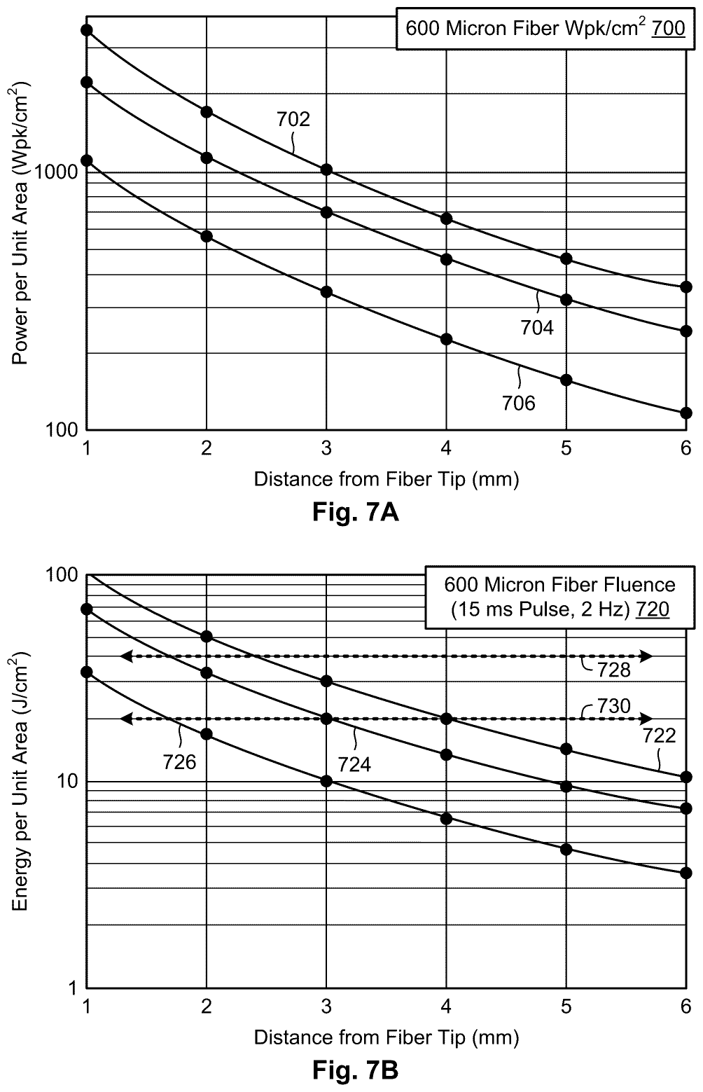

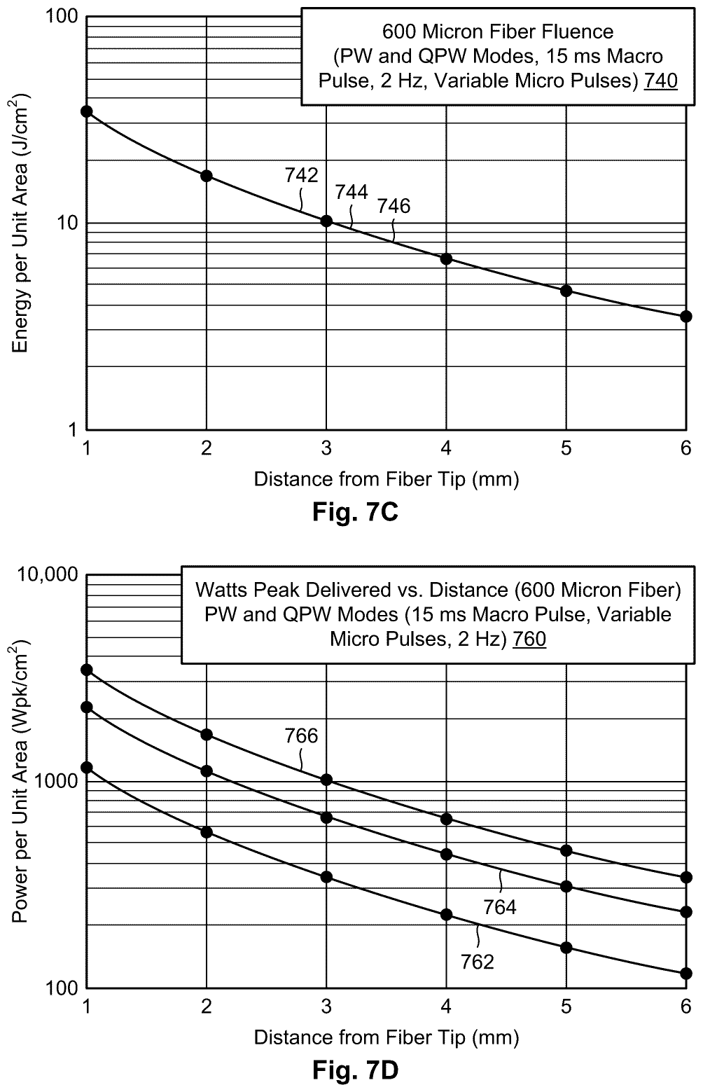

The benefits of QPW operation as compared to traditional modes include (see FIGS. 6-7D): (i) reduced tissue damage due to less carbonization and more precise cutting or coagulation; (ii) improved healing outcomes due to minimized collateral thermal injury; (iii) decreased laser size and price without the need for bulky, expensive solid-state pulsed laser systems; (iv) better control due to QPW allowing for higher peak power at reduced duty cycles, which causes a clinical effect at greater distances from the tissue; (v) more forgiving operation due to an increased range for achieving a clinical effect; (vi) increased customizability resulting from tailored pulse profiles for different surgical applications (e.g., car, nose, and throat; dermatology; urology); (vii) increased tune-ability of resulting temperature rise throughout the target; and (viii) increased effective working distance (i.e., range of efficacious tip from tissue distances) due to increased laser power (watts peak).

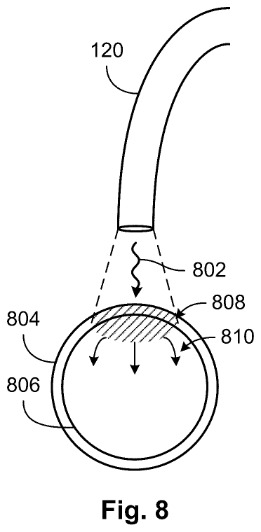

A laser operating in QPW mode in accordance with embodiments of the present disclosure is particularly effective at selective coagulation (see FIG. 8). To selectively coagulate a blood vessel, for example, the targeted vessel must absorb a given number of milli-joules of laser radiation over an optimized amount of time. That number of milli-joules varies based on the laser wavelength, as well as and the absorption coefficients and size of the target vessel. Larger vessels, for instance, require a greater number of milli-joules to drive the larger target vessel temperature rise to the coagulation threshold temperature, whereas smaller vessels require fewer milli-joules to drive the target vessel to its coagulation threshold.

Laser pulse duration can be optimized to provide selective coagulation with differing effects. For example, if the clinical goal is to coagulate a blood vessel while limiting thermal damage or thermal diffusion to adjacent tissue, then it is important for the laser pulse to be delivered within the thermal relaxation time of the targeted vessel-thereby minimizing thermal diffusion to adjacent areas. The smaller the vessel, the shorter the pulse duration. Likewise, the larger the vessel, the greater its thermal relaxation time, thus allowing for longer duration laser pulse widths.

To achieve selective vessel coagulation an amount of energy (e.g., in mJ) proportionate to the vessel size must be absorbed by the vessel resulting in the requisite vessel temperature increasing to a coagulation threshold. In case of shorter duration laser pulses, the laser peak power (e.g., in J/cm²) must be increased as compared to longer duration laser pulses so as to maintain the requisite amount of energy. For example, if the pulse duration is doubled, the laser power may be halved in order to provide an equivalent amount of energy.

Another clinical goal may be to minimize thermal diffusion to adjacent tissue areas while simultaneously preventing blood vessel ruptures (with associated bleeding into adjacent tissue areas) during the laser pulse emission. Some sensitive tissues, such as vocal folds, benefit from an absence of vessel rupture or bleeding during selective coagulation. In such cases, the clinical goal would include hemostatic selective vessel coagulation with minimized thermal diffusion to adjacent tissues while simultaneously allowing sufficient thermal diffusion throughout the vessel to achieve selective coagulation without vessel rupture or bleeding.

Selective hemostatic vessel coagulation benefits from thermal diffusion between the irradiated portion of the vessel throughout the entirety of the vessel such that the distribution of temperature rise occurs more or less evenly throughout. In this manner, an excessive temperature rise can be prevented in the irradiated portion of the vessel, for example the portion nearest the laser fiber tip, thereby preventing vessel rupture during coagulation.

While a single laser treatment pulse with a duration longer than the targeted vessel time constant or thermal relaxation time allows for some thermal diffusion during the laser emission, a multiplicity of smaller duration pulses with thermal diffusion periods between emissions allows operation at higher peak laser power while limiting the overall amount of energy delivered to the target and thereby achieving a gradual, more even heating of the entirety of the vessel.

A multiplicity of evenly spaced laser pulses comprising a treatment pulse (e.g., as in QPW operation) further average out the resulting temperature rise throughout the vessel by allowing for a multiplicity of thermal diffusion intervals where the directly irradiated region is allowed to diffuse the temperature rise throughout the vessel. This maintains hemostasis and prevents hot spots and vessel ruptures that might otherwise result from treatment without such thermal diffusion intervals.

Further, the multiplicity of smaller pulses evenly spaced to comprise the overall treatment pulse allows the use of laser wavelengths which are more strongly or more shallowly absorbed while maintaining hemostasis and achieving the desired targeted tissue temperature increase. For example, strongly absorbed laser wavelengths tend to be absorbed in the shallowest regions or layers of a targeted tissue as compared to less strongly absorbed wavelengths thusly resulting in a hot spot or in uneven heating of the targeted tissue.

The quasi-pulsed method or mode allows laser wavelengths which would otherwise be too strongly absorbed to nevertheless be used to evenly heat targeted tissue, and this is not limited to blood vessel coagulation but applies to many other applications and wavelengths other than 455 nanometers. Typical pulse durations for selective blood vessel coagulation of small vessels (e.g., less than a few mms), for instance, range from 500 microseconds to about 2-3 milliseconds, with a maximum of less than about 5 milliseconds.

A multiplicity of evenly spaced laser pulses or “micro-pulses” may be combined in sequence to form a “macro-pulse.” While treatment pulse or macro-pulse duration is selected to optimize thermal diffusion time period applied to the target for even thorough heating, this applied laser pulse may be divided up into a plurality of micro-pulses such that the desired millijoules for the target via the treatment pulse or macro-pulse may be provided at a greater laser power with evenly spaced off times within the treatment or macro-pulse. Thereby providing enhanced working distance (from the peak power) while maintaining optimum energy delivered to the target (from the pulse width) and while delivery said energy in an optimum time period to allow for the combination of direct laser irradiation and corresponding thermal diffusion to evenly heat the target.

In some embodiments, the micro-pulse minimum pulse durations within the macro-pulse are increased to provide more hemostasis and decreased to allow for greater laser peak power (greater working distance) and greater confinement of the temperature rise to the irradiate region with relatively less thermal diffusion to adjacent areas.

FIGS. 4A and 4B illustrate first and second waveforms 300 and 350 associated with pulsed and quasi-pulsed operation, respectively, according to various aspects of the subject technology. Together, these waveforms 300 and 350 highlight a benefit of QPW mode—namely, the ability to increase peak power (e.g., from 15 W to 30 W) while maintaining total energy output.

The first waveform 300, in FIG. 4A, is for a PW laser beam with pulses that each deliver 225 joules of energy. Similarly, in FIG. 4B, the second waveform 350 includes macro-pulses that each deliver 225 joules of energy. This second waveform 350, however, is for a QPW laser beam (e.g., laser beam 222) with peak power double that of the first waveform 300. Specifically, while the peak power of the pulses in the first waveform 300 is 15 watts, the peak power of the second waveform 350 pulses is 30 watts. As indicated in the embodiment of FIG. 4B, the second waveform 350 includes macro-pulses 354 made up of individual micro-pulses 352. This is typical of all QPW waveforms, though in some embodiments the widths of the micro-pulses and the amount of “downtime” between them can be adjusted. In this manner, the QPW laser beam can more effectively affect target tissue due to its increased power without damaging surrounding tissue—as discussed in more detail above. Thus, in certain embodiments, using a series of micro-pulses separated by periods of off-time to form each macro-pulse allows for the use of greater peak power than a continuous laser pulse, and this in turn allows for a greater working distance away from the target tissue.

FIG. 5 illustrates a GUI 500 for a laser device (e.g., laser device 100, 150), according to various aspects of the subject technology. In the illustrated embodiment, the GUI 500 includes interface elements 502, 504, and 506 that allow a user to access, respectively, user presets 502 for the laser device, a treatment log 504 for the laser device, and system settings 506 for the laser device.

The GUI 500 also includes a treatment mode menu 508 that allows a user to select a treatment mode (also referred to herein as an “operating mode”) for the laser device. For example, in the illustrated embodiment, the user can select pulsed mode 510 (i.e., PW mode), quasi-pulsed mode 512 (i.e., QPW mode), continuous mode 514 (i.e., CW mode), or quasi-continuous mode 516 (i.e., QCW mode). In some embodiments, selecting one of these modes 510, 512, 514, or 516 causes a signal generator (e.g., control signal generator 102) to generate a corresponding signal that in turn causes a laser (e.g., laser 114) to emit a corresponding laser beam (e.g., a QPW laser beam following selection of the QPW mode 512).

After the user selects a particular treatment mode, the GUI 500 displays various settings associated with the selected mode. In the illustrated embodiment, QPW mode 512 is selected and the GUI 500 displays settings associated with that mode, including an aiming beam setting 518, a power setting 520 (e.g., a peak-power setting), a pulse width setting 522, and a pulse per second setting 524. Notably, the GUI 500 allows the user to individually select the macro and micro-pulse widths for the laser beam (see pulse width setting 522). For instance, the user may select “Macro” and then use the up or down key to adjust the macro-pulse width. Likewise, the user can select “Micro” and then use the same keys to adjust the micro-pulse width. In some embodiments, the macro-pulse can be set to any value from 5 to 200 milliseconds. In some embodiments, the micro-pulse can be set to any of the values described above with respect to micro-width 230, for example, any value from 0.5 to 4.5 milliseconds.

The GUI 500 also displays information 526 for the selected mode, including information regarding total energy delivered and time on tissue. Additionally, the GUI 500 includes a pulse limit setting 528, standby and ready indicators 530 and 532, and a save button 534 (e.g., allowing a user to save current settings for a future procedure).

FIG. 6 illustrates working regions 604 and 614 (or regions of clinical effectiveness) associated with pulsed and quasi-pulsed operation, according to various aspects of the subject technology. In each half of FIG. 6, an optical waveguide 120 of a laser device (e.g., laser device 100, 150) is illustrated at a distance from target tissue 124. Depending on the distance between a tip of the waveguide 120 and the target tissue 124, a laser beam emitted from the tip of the waveguide 120 may have (i) no effect on the tissue 124 (see no-effect regions 602, 612), (ii) the desired clinical effect on the tissue 124 (see working region regions 604, 614), or (iii) too much impact on the tissue 124 (see too-much-power regions 606, 616).

As illustrated in FIG. 6, the working region 614 for quasi-pulsed mode is significantly larger than the working region 604 for pulsed mode (e.g., twice as large). A larger working region 614 permits a greater working distance away from the target tissue and also affords the user (e.g., surgeon) greater flexibility. While a user operating the laser device in pulsed mode must keep the waveguide 120 within a tight region (i.e., working region 604), the user can operate the waveguide 120 with more flexibility if the laser device is in quasi-pulsed mode (see working region 614).

FIGS. 7A to 7D are plots 700, 720, 740, and 760 that illustrate power per unit arca (e.g., in Wpk/cm²) or energy per unit area (e.g., in J/cm²) as a function of distance (e.g., in mm) between a fiber optic tip (e.g., of optical waveguide 120) of a laser device (e.g., laser device 100, 150) and target tissue (e.g., tissue 124), according to various aspects of the subject technology.

Note, FIGS. 7B and 7C include plots 720 and 740 involving energy per unit arca (J/cm²). This metric can be calculated, for instance, based on the following formula for energy per unit arca at distance B:

$$J / {cm}^{{}_{2}} = \frac{{W}_{p k} * t}{\{ \frac{{π [ ( B * tan 12.7 ° ) + 300 μ ]}^{2}}{10} \}}$$

where Wₚₖ is the peak power of a laser (e.g., laser device 100, 150), t denotes the amount of time the laser is directed at target tissue (e.g., tissue 124), and B denotes the distance between the tip of the laser and the target tissue.

FIG. 7A illustrates the effect on peak power per unit arca (Wpk/cm²) as a function of distance (mm) between the fiber optic tip surface and the target tissue (e.g., for PW/QPW mode), according to various aspects of the subject technology. This plot assumes 600 micron fiber emission divergence, with 15 millisecond and 2 Hertz laser pulse duration, but with three different power laser settings: (i) a 30-watt peak laser is plotted as line 702; (ii) a 20-watt peak laser is plotted as line 704; and (iii) a 10-watt peak laser is plotted as line 706.

FIG. 7B illustrates the effect on energy per unit area (J/cm²) as a function of distance (mm) between the fiber optic surface and the target tissue, according to various aspects of the subject technology. Like the plot 700 of FIG. 7A, this plot 720 assumes 600 micron fiber emission divergence, with 15 millisecond and 2 Hertz laser pulse duration, but with three different power laser settings: (i) a 30-watt peak laser is plotted as line 722; (ii) a 20-watt peak laser is plotted as line 724; and (iii) a 10-watt peak laser is plotted as line 726.

The plot 720 also includes an example observable clinical effect threshold 730 (e.g., 20 J/cm²). This threshold 730 indicates the irradiance above which a clinical effect on tissue becomes visually observable. While this threshold will vary based on tissue type (variable chromophores and resulting absorption of laser radiation), applied wavelength, and distance from the fiber tip surface, it comprises an important characteristic useful for efficacious application of laser energy to a target.

Often a clinician will select an appropriate laser power (Wpk) and pulse duration (ms) for the given wavelength and tissue target and thereafter use the fiber tip to gradually approach the target while observing the target for a visually detectable effect. Thusly the laser irradiance is gradually increased on the target until the desired effect is achieved.

In addition to the example clinical effect threshold 730, the plot 720 also includes an example overtreatment threshold 728 (e.g., 40 J/cm²). This threshold 728 indicates the irradiance above which overtreatment of the targeted tissue occurs. “Overtreatment” can include, for instance, disruption of overlying mucosal tissue, charring, unintended ablation or vaporization, and so on.

One challenge, particularly with an aggressively absorbed wavelength (i.e., a wavelength with a relatively high coefficient of absorption in the target tissue chromophores), is insufficient working distance due to the high absorption. Thus, as the fiber tip is advanced toward the target tissue, the occurrence of an initial visually observable clinical effect is rapidly followed by overtreatment (see, e.g., the small amount of space between the no-effect and too-much-power zones 602 and 606 of FIG. 6). In such cases, the observable threshold 730 is exceeded by an additional slight advance of the fiber tip of sometimes less than 1 millimeter, thereby exceeding the overtreatment threshold. Requiring the clinician to manually achieve less than 1 millimeter of fiber tip positional variation to maintain the desired effect without exceeding the overtreatment threshold 728 is often impractical and leads to marginal treatment.

In this example, the working distance or distance between the observable clinical effect threshold 730 and the overtreatment threshold 728 is (i) for the 30-watt peak laser 722, a working distance of 1.6 millimeters (with the effect and overtreatment thresholds 730 and 728 at approximately 4 and 2.4 millimeters, respectively); (ii) for the 20-watt peak laser 724, a working distance of 1.3 millimeters (with the effect and overtreatment thresholds 730 and 728 at approximately 3 and 1.7 millimeters, respectively); and (iii) for the 10-watt peak laser 726, a working distance of 0.8 millimeters (with the effect and overtreatment thresholds 730 and 728 at approximately 1.7 and 0.9 millimeters, respectively).

Through selection of laser settings the resulting working distance between the initially observable clinical effect threshold and the overtreatment threshold can be extended. More specifically, by increasing laser power (Wpk), the optimal working distance can be increased compared to lower laser power settings. Since treatment objectives often require a given amount of joules or millijoules to achieve, for example coagulation of a target, therefore the pulse duration or aggregate laser on-time during a laser pulse (laser on time within a macro-pulse) may be reduced in the case of a higher peak power setting (Wpk). Thusly the desired energy (mJ) may be delivered to the target by adjusting the micro-pulses, aggregate pulse duration, or laser on-time despite differing laser power settings (Wpk).

An increased working distance between the fiber tip and the target while maintaining irradiance or fluence within the observable effect threshold 730 and the overtreatment threshold 728 allows for better titration of the treatment by the clinician through movement between the fiber tip and the targeted tissue. The expanded working distance allows finer gradations of irradiation or fluence to be delivered to the target providing for a more precise treatment.

FIG. 7C illustrates energy delivered in PW and QPW modes, according to various aspects of the subject technology. Specifically, the plot 740 illustrates the effect on energy (J/cm²) as a function of distance (mm) between the fiber optic surface and the target tissue. This plot 740 assumes 600 micron fiber emission divergence, but with three different pulse widths and power settings: (i) a 10-watt peak laser in PW mode with 15 millisecond pulses is plotted as line 742; (ii) a 20-watt peak laser in QPW mode with 15 millisecond macro-pulses and three 2.5 millisecond micro-pulses for each macro-pulse is plotted as line 744 (for a total on-time of 7.5 ms per macro-pulse); and (iii) a 30-watt peak laser in QPW mode with 15 millisecond macro-pulses and three 1.667 millisecond micro-pulses for each macro-pulse is plotted as line 746 (for a total on-time of 5 ms per macro-pulse).

Note, in this case, all three settings deliver equivalent energy to the target within the same 15 millisecond envelope pulse duration (macro-pulse). Thus, the three lines 742, 744, and 746 overlap and are not visible independent of one another.

Since the overall pulse envelopes or pulse durations is the same for all three pulses each distinct pulse provides the same overall time period for thermal diffusion throughout the target during the macro-pulse emission period, despite the differing laser on times and peak power (Wpk). Thusly predictable, adjustable or tunable hemostasis and coagulation or ablation of targets is possible. As noted above, use of a higher peak power (Wpk) can expand the efficacious working distance or working region, thereby simplifying the clinician's achievement of a requisite tip to tissue distance.

QPW mode allows for an expanded working distance (by means of laser power selection, increase) while simultaneously maintaining the desired treatment pulse width or macro-pulse for the target by emitting a sequence of evenly spaced micro-pulses.

In some embodiments, pulse width selection (see, e.g., pulse width setting 522 of FIG. 5) is based on the treatment goal. For example, a target (e.g., target tissue 124) of a given size requires a given number of millijoules to coagulate, and the pulse width used to deliver the desired energy determines the amount of time for thermal diffusion into and throughout the target. Thus, a shorter pulse width selection better confines the temperature rise to the irradiated region and not to adjacent structures or tissues, where longer pulse durations allow for greater thermal diffusion time within and throughout the target.

With QPW mode, the laser on time (micro-pulse) within a desired pulse width (macro-pulse) allows for use of the laser at higher peak powers. In this manner, QPW mode can be used to increase working distance while maintaining a desired pulse duration, thus controlling the thermal diffusion time period and providing desired level of hemostasis. While an increase in power (Wpk) yields a wider or greater working distance and the division of the treatment pulse or macro-pulse into a sequence of smaller micro-pulses, the minimum pulse duration is limited by the treatment goal. For example, if hemostatic vessel coagulation is the goal (i.e., full vessel coagulation without a vessel bursting, bleeding, or bruising), then the minimum micro-pulse duration must be greater than the thermal relaxation time of the targeted vessel.

Thermal relaxation times for small vessels (e.g., vocal folds, tissues proximal to mucosal tissues) are about 500 microseconds (±100 μs), ranging from up to around 1 millisecond at most and down to around 300 microseconds at minimum. Thus, a treatment pulse or macro-pulse comprised of a sequence of micro-pulses no less than 0.5 to 1 millisecond can coagulate a small vessel while maintaining hemostasis, which is an important feature of many procedures.

Whereas most small vessel coagulations with acceptable hemostasis are accomplished with treatment pulse durations of about 15 to 20 milliseconds, coagulation of such vessels using QPW mode with acceptable hemostasis can be accomplished with 3 to 4 micro-pulses of between 1 to 3 milliseconds delivered over 15 to 20 milliseconds respectively or preferably with micro-pulses of about 1.5 to 2.5 milliseconds delivered over about 15 to 20 milliseconds respectively.

This example of quasi pulse mode settings takes advantage of the expanded working distance derived from increased laser power (Wpk) while maintaining overall desired treatment or macro-pulse period selected to provide the optimum thermal diffusion time period-by reducing laser on-time through division of the laser treatment or macro-pulse into a plurality of micro-pulses to maintain the requisite treatment pulse energy (millijoules) while simultaneously providing micro-pulses of sufficient minimum duration to maintain desired hemostasis throughout the treatment or macro-pulse.

This is depicted in FIG. 7C, where the same energy with the same overall pulse duration is provided and where individual micro-pulses are adjusted to emphasize greater hemostasis using, for example, up to 4.5 millisecond micro-pulses or where avoiding damage to adjacent structures or tissues is emphasized as treatment goal utilizing micro-pulses as low as 500 microseconds. In some such embodiments, preferred micro-pulse duration ranges from 1.5 to 2.5 milliseconds in order to provide optimum hemostasis for most small blood vessels.

FIG. 7D illustrates power delivered in PW and QPW modes, according to various aspects of the subject technology. Specifically, the plot 760 illustrates the effect on power (Wpk) as a function of distance (mm) between the fiber optic surface and the target tissue. This plot 740 assumes 600 micron fiber emission divergence, but with three different pulse widths and power settings: (i) a 10-watt peak laser in PW mode with 15 millisecond pulses is plotted as line 762; (ii) a 20-watt peak laser in QPW mode with 15 millisecond macro-pulses and three 2.5 millisecond micro-pulses for each macro-pulse is plotted as line 764 (for a total on-time of 7.5 ms per macro-pulse); and (iii) a 30-watt peak laser in QPW mode with 15 millisecond macro-pulses and three 1.667 millisecond micro-pulses for each macro-pulse is plotted as line 766 (for a total on-time of 5 ms per macro-pulse).

In this plot 760, all three settings deliver the same overall energy (see plot 740 of FIG. 7C) although at different peak watts, thusly the 30 watt peak QPW mode setting (line 766) is only on (i.e., laser emitting) for an aggregate of 5 milliseconds during the 15-millisecond macro-pulse, whereas the 20 watt peak QPW mode setting (line 764) is on for an aggregate of 7.5 milliseconds during the 15-milliseconds macro-pulse, and the 10 watt peak PW mode setting (line 762) is on continuously throughout the 15 millisecond pulse duration.

Therefore, all three settings deliver equivalent energy at equivalent distances over the same 15-millisecond duration while the higher power settings provide a correspondingly greater working distance (i.e., fiber-tip-to-target distance between the visually observable tissue effect threshold and the overtreatment threshold; see working regions 604, 614 of FIG. 6). All three settings deliver the same amount of tissue heating (mJ) at equivalent distances over the same 15-millisecond pulse period, and the advantages of a greater working distance provided by settings with a higher peak power may be achieved without increasing overall energy delivered to the target through reduction of aggregate laser on time into a sequence of pulses shorter than the intended coagulation pulse period (macro-pulse duration).

Additionally, the minimum micro-pulse width is maintained greater than about 1 millisecond, thereby preventing unintended results (e.g., blood vessel rupture) and improving hemostasis. In targets such as blood vessels it is necessary to heat the targets with a combination of direct irradiation but also with interleaved periods of thermal diffusion (during laser off time). Shallower regions of the vessel which are closer to the fiber act to shield deeper regions of the vessel and are also exposed to slightly higher irradiance. Therefore, shallow vessel regions may tend to rupture before deeper regions have coagulated.

For these reasons, optimum hemostatic coagulation heating of the vessel in certain embodiments is best accomplished by a series of short laser emission pulses (but no shorter than about 0.5 ms, preferably no shorter than 1 ms), interspersed with laser-off periods during which thermal diffusion from the directly irradiated region heats the deeper regions of the vessel and overall averages out the temperature rise throughout the vessel. The gaps between micro-pulses during QPW mode help accomplish this.

For emphasis, it is again noted that all three settings discussed for FIGS. 7C and 7D deliver the same amount of energy at the same distance over the same 15 millisecond total pulse duration. The QPW mode allows operation at a higher power, thus conveying the increased “working distance.” Also, the higher peak power which would otherwise risk worsening hemostasis does not worsen hemostasis since the thermal diffusion period is provided by the interleaved off times rather than just decreasing the power and increasing the pulse duration, as in PW mode. FIG. 7D shows the same data as in FIG. 7C, only it's expressed as power rather than energy. Energy takes account of the “on time” or duty cycle, whereas power simply shows the peak intensity of the emission. In the latter plot 760, the separation between the 3 lines 762, 764, and 766 is visible.

FIG. 8 illustrates a blood vessel being heated by direct irradiation and thermal diffusion, according to various aspects of the subject technology. The blood vessel is made up of a blood vessel wall 804, as well as blood 806 contained therein. As discussed extensively herein, the embodiments of the present disclosure can be used with other types of tissue in addition to blood vessels-for instance, substituting the outer layer of such other tissue for the blood vessel wall 804 and the interior region of said tissue for the blood 806 (or deeper layers of tissue, for instance, for organs).

In FIG. 8, the optical waveguide 120 directs or delivers a propagated laser emission 802 (e.g., laser beam 122, 130) from a tip thereof towards the blood vessel wall 804. Specifically, the laser emission 802 is directed at a particular region 808 of the blood vessel, and laser irradiation is directly absorbed at this region 808—causing an increase in temperature (e.g., for coagulation). As a result of this, thermal diffusion 810 causes neighboring regions not directly heated by the laser emission 802 to likewise rise in temperature. As discussed above, in some embodiments QPW mode allows for a greater effective working distance between the tip of optical waveguide 120 and the region 808 since a greater peak power can be utilized.

Technical Consideration. Laser wavelength selectivity: Laser irradiation must be absorbed to drive accumulation of thermal energy or a temperature rise in a target. Selective heating of a target requires selective absorption of laser irradiation by a chromophore present in the target but not present or present at reduced density in untargeted areas adjacent to the target such that thermal energy accumulates in the target during the applied irradiation and where heating of surrounding or adjacent areas is limited by thermal diffusion time constants from the targeted tissues to adjacent untargeted tissues.

Carbon dioxide (CO₂) lasers are preferentially absorbed by water and therefore provide tissue cutting and or ablation in biologic tissues with predictable hemostasis. CO₂ radiation must be delivered to the target tissue via either direct line of sight or via an appropriate hollow waveguide since CO₂ wavelengths will not propagate down a standard silica optical fiber. Due to the high absorption in water within biological tissues, CO₂ wavelengths therefore offer almost no selectivity of absorption between tissues. This relative lack of CO₂ wavelength selectivity of absorption between different tissues works well for cutting and ablation functions whereas selective coagulation of a target requires a wavelength selectively absorbed by that target and not absorbed by the adjacent untargeted tissues.

Selective coagulation of for example blood vessels requires a wavelength absorbed by a chromophore in the target vessels and which is not present (or is present at reduced density) in untargeted adjacent tissues such that targeted vessels preferentially absorb the wavelength and where adjacent tissues do not. Thus, the capability required to selectively heat and coagulate blood vessels while protecting adjacent untargeted tissues requires a wavelength other than CO₂.

Pulsed mode or temporal laser selectivity: In order to confine absorbed laser radiation driven temperature rise within a target or targeted structure, it is important to deliver the laser radiation within the thermal relaxation time of the targeted tissue. Thermal relaxation time for a target can be defined as the time for a target to dissipate a percentage, for example 63%, of the thermal energy deposited by the laser irradiation.

Target selectivity wherein thermal energy absorbed by the target is more or less selectively absorbed by the target and that energy delivered within the targets' thermal relaxation time results in a temperature rise largely confined to the target thus selectively damaging or destroying the target while largely avoiding damage due to dissipation of the targets' accumulated thermal energy through thermal diffusion into areas or tissues nearby or adjacent to the target. Thus, smaller targets require shorter duration laser pulses to provide selective heating of the target whereas effective cutting or ablation of tissues requires longer duration exposures.

Thus, in cutting or ablation applications, absorption of irradiation in a selected target chromophore relies on thermal diffusion to heat adjacent or surrounding tissue lacking absorptive chromophores relative to the applied wavelength and thermal diffusion takes time irrespective of laser pulse duration. Therefore, laser irradiation intervals or pulse durations longer than those used for selective coagulation and longer than the thermal time constant of the Tissues or structures in the targeted area are used to perform cuts or ablation of targets.

Additionally, when considering laser cutting or ablation of tissue the use of a wavelength with generally uniform absorption in all areas of the intended cut is most common, for example CO₂ laser wavelengths with strong absorption in water will drive a temperature rise in all water containing tissues. Thus, tissue cutting or ablation is driven by direct absorption of the CO₂ laser irradiation beam which causes a temperature rise sufficient to cut or ablate tissue in all water containing tissues within the irradiated region.

When considering a more selective wavelength lacking a generally uniform absorption in all areas of the intended cutting or ablation region both direct absorption and thermal diffusion act to increase temperatures throughout the area of the intended cut. In this case pulse durations and inter pulse delays may be selected to tune or select the proportion of heating which is accomplished by direct laser absorption and that which is accomplished by thermal diffusion. Thus, shorter pulse durations tend toward confinement of heating to the directly absorbing regions and longer pulse durations allow the conduction of heating via thermal diffusion to areas adjacent the directly absorbing regions.

Pulse durations which are shorter than the time constant of the chromophore containing tissue or structures within the cut or ablation targeted region will substantially confine heating to the chromophore containing region or structure and where thermal diffusion and corresponding temperature rise of adjacent areas is reduced. For this reason, longer or even CW pulse durations are essential to perform cutting or ablation with a laser wavelength which is only selectively absorbed by portions of the targeted areas and where some portions of that area contain no or relatively few chromophores for the given wavelength to be absorbed by.

When applying a wavelength lacking a generally uniform absorption in all areas of the intended cutting or ablation region, selection of pulse duration may be adjusted to increase or decrease thermal diffusion into adjacent areas thereby increasing or decreasing the cut or ablation depth and or width.

To perform effective cuts of tissues including constituents of which contain absorptive chromophores and constituents or adjacent areas which lack selectively absorbed chromophores of the applied wavelength, laser pulse durations deliberately greater than the time constant of the chromophore containing target may be used to enhance thermal diffusion into desired area near the chromophore containing target. Thus, laser irradiation, rather than confining temperature rise to the absorptive target by means of short pulse durations, instead relies on longer pulse durations to enhance thermal diffusion from absorptive tissue area or targets into adjacent or nearby tissue areas to cut or ablate them. Cut and or ablation depth and width can therefore be tuned by selection of pulse duration.

For a given fixed average power, longer pulse duration or CW emissions maximize cut depth and width and shorter pulse durations or continuous pulse trains consisting of shorter pulse durations with an inter-pulse delay (quasi-continuous wave) may be used to reduce cut depth and width while at the same average power as in CW emission mode. In some embodiments, CW mode is particularly useful for large bulky excisions with predictable hemostasis whereas QCW mode is adjustable to confer more shallow, more confined cuts or ablations—thereby protecting adjacent tissues from undesired laser irradiation and providing a more gentle or fine cut or ablation capability (e.g., as compared to CW mode).

Generally, the goal in laser surgeries is to confine damage to chromophore-rich tissue. However, sometimes lasers are used to damage adjacent tissue structures and not just the targeted, chromophore-rich tissue. For example, fat cells and liposomes are damages at lower temperatures than fibrous tissue, such as septae which are present throughout fatty or liposome-rich regions of the body. In this case, the septae could be targeted with a given wavelength (e.g., 455 nm) and heated for a long duration at relatively low power such that the septae absorb the wavelength and thermally diffuse to adjacent liposome tissue.

Additionally, cancer tumors are commonly chaotically vascularized with dense concentrations of blood vessels. By using a selective wavelength (e.g., 455 nm, 532 nm), long duration pulses or CWs could gradually heat vessels so as to promote or maximize thermal diffusion from vessels into adjacent tumor areas. In this manner, thermal diffusion can be used for damaging or lysing areas between vessels, whereafter laser power can be increased and/or pulse durations decreased so as to directly target the vessels within the targeted tumor. Cancer tumors can thereby be targeted by first using thermal diffusion from the laser being absorbed into vessel chromophores and then by more rapid heating of vessels within the tumor to directly coagulate them via laser absorption.

QCW cutting depth control (depth reduction) is conferred by a stream of equally-spaced pulses of various duty cycles such that small areas are irradiated with micro-pulses and where thermal diffusion of the resulting temperature increase into adjacent areas is controlled by adjustment of the cooling period between micro-pulses (inter-pulse delay) and the rate of motion of the fiber optic tip over or across the tissue. In some embodiments, QCW mode allows a user to adjust the duty cycle from anywhere between 20-66%. In some embodiments, QCW mode allows the user to adjust the frequency from 50-1000 Hz.

One advantage of cut or ablation adjustability is in delicate microsurgeries or in neurosurgical applications or any surgical application dependent on preventing thermal diffusion driven damage to adjacent tissue areas. 455 nm is strongly absorbed by hemoglobin and thus may be advantageous for coagulation during cutting or ablating functions according to certain embodiments. Sufficiently high 455 nm peak power is required to provide hemostasis whereas control or reduction of cut and or ablation depth as well as limitation of thermal damage to adjacent sensitive tissue areas is accomplished by reduction in pulse duration which thereby reduces time available for thermal diffusion into untargeted nearby tissue areas. Pulse duration controls the apportionment of the amount of heating due to direct laser absorption vs. that of thermal diffusion wherein shorter pulse durations confine temperature increases to directly absorbed chromophore containing tissue regions and where longer pulse durations allow more time for thermal diffusion driven temperature increase to areas adjacent to the directly absorbed tissue regions. Thus, to deliberately increase thermal diffusion to adjacent untargeted or poorly absorbing nearby tissue areas, longer duration pulses at reduced power levels are applied. Whereas to reduce thermal diffusion and confine temperature increases to the directly absorbing tissue regions shorter duration but higher power pulses are used.

Illustrative Clauses. For further reference, example aspects of the present disclosure are included below as numbered clauses. These clauses are provided for illustrative purposes and are not intended to limit the subject technology.

Clause 1. A laser device comprising: a signal generator configured to separately generate (i) a PW signal, (ii) a QPW signal, (iii) a CW signal, or (iv) a QCW signal for transmission as a laser control signal; a laser source configured to receive the laser control signal and emit a laser beam responsive to receiving the laser control signal and in accordance with the laser control signal, wherein the laser beam comprises (i) a PW laser beam, (ii) a QPW laser beam, (iii) a CW laser beam, or (iv) a QCW laser beam; another laser source configured to receive the laser control signal and emit another laser beam responsive to receiving the laser control signal and in accordance with the laser control signal, wherein the other laser beam comprises (i) a PW laser beam, (ii) a QPW laser beam, (iii) a CW laser beam, or (iv) a QCW laser beam; a selective turning mirror configured to transmit the laser beam and reflect the other laser beam; and a turning mirror configured to reflect the laser beam and reflect the other laser beam; and control circuitry configured to: receive a user request to operate in a requested mode comprising (i) a PW mode, (ii) a QPW mode, (iii) a CW mode, or (iv) a QCW mode; and responsive to receiving the user request, cause the signal generator to generate the laser control signal in accordance with the requested mode; wherein the selective turning mirror and the turning mirror are positioned relative to the laser source, the other laser source, and a first end of an optical waveguide such that (i) the laser beam is received at the first end of the optical waveguide after the laser beam is transmitted through the selective turning mirror and then reflected off the turning mirror, (ii) the other laser beam is received at the first end of the optical waveguide after the laser beam is reflected off the selective turning mirror and then reflected off the turning mirror, and (iii) the laser beam and the other laser beam are concurrently received at the first end of the optical waveguide as a multiplexed laser beam comprising the laser beam and the other laser beam; and wherein the optical waveguide is configured to emit the multiplexed laser beam from a second end of the optical waveguide responsive to receiving the multiplexed laser beam at the first end of the optical waveguide.

Clause 2. A laser device comprising: a signal generator configured to separately generate two or more of (i) a PW signal, (ii) a QPW signal, (iii) a CW signal, and (iv) a QCW signal for transmission as a laser control signal; a laser source configured to receive the laser control signal and emit a laser beam responsive to receiving the laser control signal and in accordance with the laser control signal, wherein the laser beam comprises either (i) a PW laser beam, (ii) a QPW laser beam, (iii) a CW laser beam, or (iv) a QCW laser beam; and control circuitry configured to: receive a user request to operate in a requested mode comprising either (i) a PW mode, (ii) a QPW mode, (iii) a CW mode, or (iv) a QCW mode; responsive to receiving the user request, cause the signal generator to generate the laser control signal in accordance with the requested mode; and wherein an optical waveguide is configured to emit the laser beam from a second end of the optical waveguide after receiving the laser beam at a first end of the optical waveguide.

Clause 3. The laser device of either Clause 1 or 2, wherein the control circuitry is further configured to, after causing the signal generator to generate the laser control signal in accordance with the requested mode: receive another user request to operate in another requested mode comprising either (i) the PW mode, (ii) the QPW mode, (iii) the CW mode, or (iv) the QCW mode; and responsive to receiving the other user request, cause the signal generator to generate the laser control signal in accordance with the other requested mode.

Clause 4. The laser device of either Clause 2 or 3, further comprising: another laser source configured to receive the laser control signal and emit another laser beam responsive to receiving the laser control signal and in accordance with the laser control signal, wherein the other laser beam comprises either (i) a PW laser beam, (ii) a QPW laser beam, (iii) a CW laser beam, or (iv) a QCW laser beam; wherein the optical waveguide is further configured to emit a multiplexed laser beam from the second end of the optical waveguide responsive to receiving the multiplexed laser beam at the first end of the optical waveguide, the multiplexed laser beam comprising the laser beam and the other laser beam.

Clause 5. The laser device of Clause 4, further comprising: a selective turning mirror configured to transmit the laser beam and reflect the other laser beam; and a turning mirror configured to reflect the laser beam and reflect the other laser beam; wherein the selective turning mirror and the turning mirror are positioned relative to the laser source, the other laser source, and the first end of the optical waveguide such that (i) the laser beam is received at the first end of the optical waveguide after the laser beam is transmitted through the selective turning mirror and then reflected off the turning mirror, (ii) the other laser beam is received at the first end of the optical waveguide after the laser beam is reflected off the selective turning mirror and then reflected off the turning mirror, and (iii) the laser beam and the other laser beam are concurrently received at the first end of the optical waveguide as the multiplexed laser beam.

Clause 6. The laser device of any one of Clauses 1, 4, or 5, further comprising: a focusing lens configured to focus the multiplexed laser beam; wherein the focusing lens is positioned relative to the first end of the optical waveguide such that the multiplexed laser beam is focused by the focusing lens before the multiplexed laser beam is received at the first end of the optical waveguide.

Clause 7. The laser device of any one of Clauses 1 and 4 through 6, wherein: the laser beam has a wavelength between 450-460 nanometers while the laser source is operating in the QCW mode; and/or the other laser beam has a wavelength between 1060-1070 nanometers while the other laser source is operating in the QCW mode.

Clause 8. The laser device of any one of Clauses 1 and 4 through 7, wherein: the laser beam has a pulse duration between 500-50,000 microseconds while the laser source is operating in the PW mode or the QPW mode; and the other laser beam has a pulse duration between 500-50,000 microseconds while the other laser source is operating in the PW mode or the QPW mode.

Clause 9. The laser device of any one of Clauses 1 and 4 through 8, wherein: the laser beam has a power output between 10-30 watts; and the other laser beam has a power output between 10-80 watts.

Clause 10. The laser device of any one of Clauses 1 through 9, further comprising: an RFID reader configured to read from and write to an RFID tag embedded within the optical waveguide, wherein the RFID tag comprises a unique identifier associated with the optical waveguide; wherein the control circuitry is further configured to: cause the RFID reader to read the unique identifier from the RFID tag; identify the optical waveguide based on the unique identifier; and write a use identifier to the RFID tag, wherein the use identifier indicates that the optical waveguide has been used in a surgical procedure.

Clause 11. The laser device of Clause 10, wherein the control circuitry is further configured to: cause the RFID reader to read the use identifier from the RFID tag; determine that the optical waveguide has been used in a surgical procedure based on the use identifier; and reject the optical waveguide responsive to determining that the optical waveguide has been used in a surgical procedure.

Clause 12. A laser system comprising: a signal generator configured to separately generate two or more of (i) a PW signal, (ii) a QPW signal, (iii) a CW signal, and (iv) a QCW signal for transmission as a laser control signal; a laser source configured to receive the laser control signal and emit a laser beam responsive to receiving the laser control signal and in accordance with the laser control signal, wherein the laser beam comprises either (i) a PW laser beam, (ii) a QPW laser beam, (iii) a CW laser beam, or (iv) a QCW laser beam; an optical waveguide configured to emit the laser beam from a second end of the optical waveguide after receiving the laser beam at a first end of the optical waveguide; and control circuitry configured to: receive a user request to operate in a requested mode comprising either (i) a PW mode, (ii) a QPW mode, (iii) a CW mode, or (iv) a QCW mode; responsive to receiving the user request, cause the signal generator to generate the laser control signal in accordance with the requested mode.

Clause 13. The laser system of Clause 12, wherein the control circuitry is further configured to, after causing the signal generator to generate the laser control signal in accordance with the requested mode: receive another user request to operate in another requested mode comprising cither (i) the PW mode, (ii) the QPW mode, (iii) the CW mode, or (iv) the QCW mode; and responsive to receiving the other user request, cause the signal generator to generate the laser control signal in accordance with the other requested mode.

Clause 14. The laser system of either Clause 12 or 13, further comprising: another laser source configured to receive the laser control signal and emit another laser beam responsive to receiving the laser control signal and in accordance with the laser control signal, wherein the other laser beam comprises either (i) a PW laser beam, (ii) a QPW laser beam, (iii) a CW laser beam, or (iv) a QCW laser beam; wherein the optical waveguide is further configured to emit a multiplexed laser beam from the second end of the optical waveguide responsive to receiving the multiplexed laser beam at the first end of the optical waveguide, the multiplexed laser beam comprising the laser beam and the other laser beam.

Clause 15. The laser system of Clause 14, further comprising: a selective turning mirror configured to transmit the laser beam and reflect the other laser beam; and a turning mirror configured to reflect the laser beam and reflect the other laser beam; wherein the selective turning mirror and the turning mirror are positioned relative to the laser source, the other laser source, and the first end of the optical waveguide such that (i) the laser beam is received at the first end of the optical waveguide after the laser beam is transmitted through the selective turning mirror and then reflected off the turning mirror, (ii) the other laser beam is received at the first end of the optical waveguide after the laser beam is reflected off the selective turning mirror and then reflected off the turning mirror, and (iii) the laser beam and the other laser beam are concurrently received at the first end of the optical waveguide as the multiplexed laser beam.

Clause 16. The laser system of either Clause 14 or 15, further comprising: a focusing lens configured to focus the multiplexed laser beam; wherein the focusing lens is positioned relative to the first end of the optical waveguide such that the multiplexed laser beam is focused by the focusing lens before the multiplexed laser beam is received at the first end of the optical waveguide.

Clause 17. The laser system of any one of Clauses 14 through 16, wherein: the laser beam has a wavelength between 450-460 nanometers while the laser source is operating in the QCW mode; and/or the other laser beam has a wavelength between 1060-1070 nanometers while the other laser source is operating in the QCW mode.

Clause 18. The laser system of any one of Clauses 14 through 17, wherein: the laser beam has a pulse duration between 500-50,000 microseconds while the laser source is operating in the PW mode or the QPW mode; and the other laser beam has a pulse duration between 500-50,000 microseconds while the other laser source is operating in the PW mode or the QPW mode.

Clause 19. The laser system of any one of Clauses 14 through 18, wherein: the laser beam has a power output between 10-30 watts; and the other laser beam has a power output between 10-80 watts.

Clause 20. The laser system of any one of Clauses 12 through 19, further comprising: an RFID reader configured to read from and write to an RFID tag embedded within the optical waveguide, wherein the RFID tag comprises a unique identifier associated with the optical waveguide; wherein the control circuitry is further configured to: cause the RFID reader to read the unique identifier from the RFID tag; identify the optical waveguide based on the unique identifier; and write a use identifier to the RFID tag, wherein the use identifier indicates that the optical waveguide has been used in a surgical procedure.

Clause 21. The laser system of Clause 20, wherein the control circuitry is further configured to: cause the RFID reader to read the use identifier from the RFID tag; determine that the optical waveguide has been used in a surgical procedure based on the use identifier; and reject the optical waveguide responsive to determining that the optical waveguide has been used in a surgical procedure.

Clause 22. A computer-implemented method for operation of a laser device with multi-mode capabilities, the method comprising: receiving a user request to operate a laser device in a requested mode comprising either (i) a PW mode, (ii) a QPW mode, (iii) a CW mode, or (iv) a QCW mode; responsive to receiving the user request, causing a signal generator of the laser device to generate a laser control signal in accordance with the requested mode; wherein the signal generator is configured to separately generate two or more of (i) a PW signal, (ii) a QPW signal, (iii) a CW signal, and (iv) a QCW signal for transmission as a laser control signal; wherein the laser device further comprises a laser source configured to receive the laser control signal and emit a laser beam responsive to receiving the laser control signal and in accordance with the laser control signal, wherein the laser beam comprises either (i) a PW laser beam, (ii) a QPW laser beam, (iii) a CW laser beam, or (iv) a QCW laser beam; and wherein an optical waveguide is configured to emit the laser beam from a second end of the optical waveguide after receiving the laser beam at a first end of the optical waveguide.

Clause 23. The computer-implemented method of Clause 22, further comprising, after causing the signal generator to generate the laser control signal in accordance with the requested mode: receiving another user request to operate in another requested mode comprising either (i) the PW mode, (ii) the QPW mode, (iii) the CW mode, or (iv) the QCW mode; and responsive to receiving the other user request, causing the signal generator to generate the laser control signal in accordance with the other requested mode.

Clause 24. The computer-implemented method of either Clause 22 or 23, wherein: the laser device further comprises another laser source configured to receive the laser control signal and emit another laser beam responsive to receiving the laser control signal and in accordance with the laser control signal, the other laser beam comprising either (i) a PW laser beam, (ii) a QPW laser beam, (iii) a CW laser beam, or (iv) a QCW laser beam; and the optical waveguide is further configured to emit a multiplexed laser beam from the second end of the optical waveguide responsive to receiving the multiplexed laser beam at the first end of the optical waveguide, the multiplexed laser beam comprising the laser beam and the other laser beam.

Clause 25. The computer-implemented method of Clause 24, wherein: the laser device further comprises a selective turning mirror configured to transmit the laser beam and reflect the other laser beam and a turning mirror configured to reflect the laser beam and reflect the other laser beam; and the selective turning mirror and the turning mirror are positioned relative to the laser source, the other laser source, and the first end of the optical waveguide such that (i) the laser beam is received at the first end of the optical waveguide after the laser beam is transmitted through the selective turning mirror and then reflected off the turning mirror, (ii) the other laser beam is received at the first end of the optical waveguide after the laser beam is reflected off the selective turning mirror and then reflected off the turning mirror, and (iii) the laser beam and the other laser beam are concurrently received at the first end of the optical waveguide as the multiplexed laser beam.

Clause 26. The computer-implemented method of either Clause 24 or 25, wherein: the laser device further comprises a focusing lens configured to focus the multiplexed laser beam; and the focusing lens is positioned relative to the first end of the optical waveguide such that the multiplexed laser beam is focused by the focusing lens before the multiplexed laser beam is received at the first end of the optical waveguide.

Clause 27. The computer-implemented method of any one of Clauses 24 through 26, wherein: the laser beam has a wavelength between 450-460 nanometers while the laser source is operating in the QCW mode; and/or the other laser beam has a wavelength between 1060-1070 nanometers while the other laser source is operating in the QCW mode.

Clause 28. The computer-implemented method of any one of Clauses 24 through 27, wherein: the laser beam has a pulse duration between 500-50,000 microseconds while the laser source is operating in the PW mode or the QPW mode; and the other laser beam has a pulse duration between 500-50,000 microseconds while the other laser source is operating in the PW mode or the QPW mode.

Clause 29. The computer-implemented method of any one of Clauses 24 through 28, wherein: the laser beam has a power output between 10-30 watts; and the other laser beam has a power output between 10-80 watts.

Clause 30. The computer-implemented method of any one of Clauses 22 through 29, wherein: the laser device further comprises an RFID reader configured to read from and write to an RFID tag embedded within the optical waveguide, wherein the RFID tag comprises a unique identifier associated with the optical waveguide; and the method further comprises: causing the RFID reader to read the unique identifier from the RFID tag; identifying the optical waveguide based on the unique identifier; and writing a use identifier to the RFID tag, wherein the use identifier indicates that the optical waveguide has been used in a surgical procedure.

Clause 31. The computer-implemented method of Clause 30, further comprising: causing the RFID reader to read the use identifier from the RFID tag; determining that the optical waveguide has been used in a surgical procedure based on the use identifier; and rejecting the optical waveguide responsive to determining that the optical waveguide has been used in a surgical procedure.

Clause 32. A non-transitory, computer-readable medium storing instructions that, when executed by a processor of a laser device, cause the laser device to perform operations comprising: receiving a user request to operate a laser device in a requested mode comprising either (i) a PW mode, (ii) a QPW mode, (iii) a CW mode, or (iv) a QCW mode; responsive to receiving the user request, causing a signal generator of the laser device to generate a laser control signal in accordance with the requested mode; wherein the signal generator is configured to separately generate two or more of (i) a PW signal, (ii) a QPW signal, (iii) a CW signal, and (iv) a QCW signal for transmission as a laser control signal; wherein a laser source of the laser device is configured to receive the laser control signal and emit a laser beam responsive to receiving the laser control signal and in accordance with the laser control signal, wherein the laser beam comprises either (i) a PW laser beam, (ii) a QPW laser beam, (iii) a CW laser beam, or (iv) a QCW laser beam; and wherein an optical waveguide is configured to emit the laser beam from a second end of the optical waveguide after receiving the laser beam at a first end of the optical waveguide.

Clause 33. The non-transitory, computer-readable medium of Clause 32, wherein the operations further comprise, after causing the signal generator to generate the laser control signal in accordance with the requested mode: receiving another user request to operate in another requested mode comprising either (i) the PW mode, (ii) the QPW mode, (iii) the CW mode, or (iv) the QCW mode; and responsive to receiving the other user request, causing the signal generator to generate the laser control signal in accordance with the other requested mode.

Clause 34. The non-transitory, computer-readable medium of either Clause 32 or 33, wherein: the laser device further comprises another laser source configured to receive the laser control signal and emit another laser beam responsive to receiving the laser control signal and in accordance with the laser control signal, the other laser beam comprising either (i) a PW laser beam, (ii) a QPW laser beam, (iii) a CW laser beam, or (iv) a QCW laser beam; and the optical waveguide is further configured to emit a multiplexed laser beam from the second end of the optical waveguide responsive to receiving the multiplexed laser beam at the first end of the optical waveguide, the multiplexed laser beam comprising the laser beam and the other laser beam.

Clause 35. The non-transitory, computer-readable medium of Clause 34, wherein: the laser device further comprises a selective turning mirror configured to transmit the laser beam and reflect the other laser beam and a turning mirror configured to reflect the laser beam and reflect the other laser beam; and the selective turning mirror and the turning mirror are positioned relative to the laser source, the other laser source, and the first end of the optical waveguide such that (i) the laser beam is received at the first end of the optical waveguide after the laser beam is transmitted through the selective turning mirror and then reflected off the turning mirror, (ii) the other laser beam is received at the first end of the optical waveguide after the laser beam is reflected off the selective turning mirror and then reflected off the turning mirror, and (iii) the laser beam and the other laser beam are concurrently received at the first end of the optical waveguide as the multiplexed laser beam.

Clause 36. The non-transitory, computer-readable medium of either Clause 34 or 35, wherein: the laser device further comprises a focusing lens configured to focus the multiplexed laser beam; and the focusing lens is positioned relative to the first end of the optical waveguide such that the multiplexed laser beam is focused by the focusing lens before the multiplexed laser beam is received at the first end of the optical waveguide.

Clause 37. The non-transitory, computer-readable medium of any one of Clauses 34 through 36, wherein: the laser beam has a wavelength between 450-460 nanometers while the laser source is operating in the QCW mode; and/or the other laser beam has a wavelength between 1060-1070 nanometers while the other laser source is operating in the QCW mode.

Clause 38. The non-transitory, computer-readable medium of any one of Clauses 34 through 37, wherein: the laser beam has a pulse duration between 500-50,000 microseconds while the laser source is operating in the PW mode or the QPW mode; and the other laser beam has a pulse duration between 500-50,000 microseconds while the other laser source is operating in the PW mode or the QPW mode.

Clause 39. The non-transitory, computer-readable medium of any one of Clauses 34 through 38, wherein: the laser beam has a power output between 10-30 watts; and the other laser beam has a power output between 10-80 watts.

Clause 40. The non-transitory, computer-readable medium of any one of Clauses 32 through 39, wherein: the laser device further comprises an RFID reader configured to read from and write to an RFID tag embedded within the optical waveguide, wherein the RFID tag comprises a unique identifier associated with the optical waveguide; and the operations further comprise: causing the RFID reader to read the unique identifier from the RFID tag; identifying the optical waveguide based on the unique identifier; and writing a use identifier to the RFID tag, wherein the use identifier indicates that the optical waveguide has been used in a surgical procedure.

Clause 41. The non-transitory, computer-readable medium of Clause 40, wherein the operations further comprise: causing the RFID reader to read the use identifier from the RFID tag; determining that the optical waveguide has been used in a surgical procedure based on the use identifier; and rejecting the optical waveguide responsive to determining that the optical waveguide has been used in a surgical procedure.

Clause 42. A method of manufacturing a laser device, the method comprising: providing a signal generator configured to separately generate two or more of (i) a PW signal, (ii) a QPW signal, (iii) a CW signal, and (iv) a QCW signal for transmission as a laser control signal; providing a laser source configured to receive the laser control signal and emit a laser beam responsive to receiving the laser control signal and in accordance with the laser control signal, wherein the laser beam comprises either (i) a PW laser beam, (ii) a QPW laser beam, (iii) a CW laser beam, or (iv) a QCW laser beam; providing control circuitry configured to: receive a user request to operate in a requested mode comprising either (i) a PW mode, (ii) a QPW mode, (iii) a CW mode, or (iv) a QCW mode; responsive to receiving the user request, cause the signal generator to generate the laser control signal in accordance with the requested mode; providing a housing for the signal generator, the laser source, and the control circuitry; situating the signal generator, the laser source, and the control circuitry in the housing; and connecting the control circuitry to the signal generator and the laser source; wherein an optical waveguide is configured to emit the laser beam from a second end of the optical waveguide after receiving the laser beam at a first end of the optical waveguide while the first end of the optical waveguide is connected to the housing.

Clause 43. The method of manufacturing of Clause 42, wherein the control circuitry is further configured to, after causing the signal generator to generate the laser control signal in accordance with the requested mode: receive another user request to operate in another requested mode comprising either (i) the PW mode, (ii) the QPW mode, (iii) the CW mode, or (iv) the QCW mode; and responsive to receiving the other user request, cause the signal generator to generate the laser control signal in accordance with the other requested mode.

Clause 44. The method of manufacturing of either Clause 42 or 43, further comprising: providing another laser source configured to receive the laser control signal and emit another laser beam responsive to receiving the laser control signal and in accordance with the laser control signal, wherein the other laser beam comprises either (i) a PW laser beam, (ii) a QPW laser beam, (iii) a CW laser beam, or (iv) a QCW laser beam; situating the other laser source in the housing; and connecting the control circuitry to the other laser source; wherein the optical waveguide is further configured to emit a multiplexed laser beam from the second end of the optical waveguide responsive to receiving the multiplexed laser beam at the first end of the optical waveguide, the multiplexed laser beam comprising the laser beam and the other laser beam.

Clause 45. The method of manufacturing of Clause 44, further comprising: providing a selective turning mirror configured to transmit the laser beam and reflect the other laser beam; providing a turning mirror configured to reflect the laser beam and reflect the other laser beam; and situating the selective turning mirror and the turning mirror in the housing, wherein the selective turning mirror and the turning mirror are positioned relative to the laser source, the other laser source, and a portion of the housing configured to connect to the first end of the optical waveguide such that (i) the laser beam is received at the first end of the optical waveguide after the laser beam is transmitted through the selective turning mirror and then reflected off the turning mirror, (ii) the other laser beam is received at the first end of the optical waveguide after the laser beam is reflected off the selective turning mirror and then reflected off the turning mirror, and (iii) the laser beam and the other laser beam are concurrently received at the first end of the optical waveguide as the multiplexed laser beam.

Clause 46. The method of manufacturing of either Clause 44 or 45, further comprising: providing a focusing lens configured to focus the multiplexed laser beam; and situating the focusing lens in the housing, wherein the focusing lens is positioned relative to a portion of the housing configured to connect to the first end of the optical waveguide such that the multiplexed laser beam is focused by the focusing lens before the multiplexed laser beam is received at the first end of the optical waveguide.

Clause 47. The method of manufacturing of any one of Clauses 44 through 46, wherein: the laser beam has a wavelength between 450-460 nanometers while the laser source is operating in the QCW mode; and/or the other laser beam has a wavelength between 1060-1070 nanometers while the other laser source is operating in the QCW mode.

Clause 48. The method of manufacturing of any one of Clauses 44 through 47, wherein: the laser beam has a pulse duration between 500-50,000 microseconds while the laser source is operating in the PW mode or the QPW mode; and the other laser beam has a pulse duration between 500-50,000 microseconds while the other laser source is operating in the PW mode or the QPW mode.

Clause 49. The method of manufacturing of any one of Clauses 44 through 48, wherein: the laser beam has a power output between 10-30 watts; and the other laser beam has a power output between 10-80 watts.

Clause 50. The method of manufacturing of any one of Clauses 42 through 49, further comprising: providing an RFID reader configured to read from and write to an RFID tag embedded within the optical waveguide, wherein the RFID tag comprises a unique identifier associated with the optical waveguide; situating the RFID reader in the housing; and connecting the control circuitry to the RFID reader; wherein the control circuitry is further configured to: cause the RFID reader to read the unique identifier from the RFID tag; identify the optical waveguide based on the unique identifier; and write a use identifier to the RFID tag, wherein the use identifier indicates that the optical waveguide has been used in a surgical procedure.

Clause 51. The method of manufacturing of Clause 50, wherein the control circuitry is further configured to: cause the RFID reader to read the use identifier from the RFID tag; determine that the optical waveguide has been used in a surgical procedure based on the use identifier; and reject the optical waveguide responsive to determining that the optical waveguide has been used in a surgical procedure.

Clause 52. A laser device comprising: a signal generator configured to separately generate one or more signals for transmission as a laser control signal, wherein the one or more signals comprises a QPW signal; a laser source configured to receive the laser control signal and emit a QPW laser beam responsive to receiving the laser control signal; a display configured to present a user interface; and control circuitry configured to: receive a user request to operate in a requested mode comprising a QPW mode; responsive to receiving the user request, cause the signal generator to generate the laser control signal in accordance with the requested mode; responsive to receiving the user request, cause the display to present, via the user interface, a micro-pulse width for the QPW laser beam and a macro-pulse width for the QPW laser beam; receive a particular micro-pulse width and a particular macro-pulse width; limit the particular micro-pulse width to a first preferred range of 1 to 3 milliseconds, wherein the micro-pulse width is constrained to the first preferred range; limit the particular macro-pulse width to a second preferred range of 15 to 25 milliseconds, wherein the macro-pulse width is constrained to the second preferred range; and while the laser source is emitting the QPW laser beam, cause the laser source to emit the QPW laser beam with the particular micro-pulse width and the particular macro-pulse width; wherein an optical waveguide is configured to emit the QPW laser beam from a second end of the optical waveguide after receiving the laser beam at a first end of the optical waveguide.

Clause 53. A laser device comprising: a signal generator configured to separately generate one or more signals for transmission as a laser control signal, wherein the one or more signals comprises a QPW signal; a laser source configured to receive the laser control signal and emit a QPW laser beam responsive to receiving the laser control signal; and control circuitry configured to: receive a user request to operate in a requested mode comprising a QPW mode; and responsive to receiving the user request, cause the signal generator to generate the laser control signal in accordance with the requested mode; wherein an optical waveguide is configured to emit the laser beam from a second end of the optical waveguide after receiving the laser beam at a first end of the optical waveguide.

Clause 54. The laser device of clause 53, further comprising a display configured to present a user interface, wherein the control circuitry is further configured to: responsive to receiving the user request to operate in the requested mode being the QPW mode, cause the display to present, via the user interface, parameters for the QPW laser beam; receive user adjustments to the parameters for the QPW laser beam; and while the laser source is emitting the QPW laser beam, cause the laser source to emit the QPW laser beam according to the user adjustments to the parameters for the QPW laser beam.

Clause 55. The laser device of clause 54, wherein: the parameters for the QPW laser beam comprise a micro-pulse width for the QPW laser beam and a macro-pulse width for the QPW laser beam; receiving the user adjustments to the parameters comprises receiving a particular micro-pulse width and a particular macro-pulse width; and causing the laser source to emit the QPW laser beam according to the user adjustments comprises causing the laser source to emit the QPW laser beam with the particular micro-pulse width and the particular macro-pulse width.

Clause 56. The laser device of clause 55, wherein: the micro-pulse width is constrained to a first range of 1 to 3 milliseconds; the macro-pulse width is constrained to a second range of 10 to 30 milliseconds; and the control circuitry is configured to, after receiving the particular micro-pulse width and the particular macro-pulse width and before causing the laser source to emit the QPW laser beam: limit the particular micro-pulse width to the first range; and limit the particular macro-pulse width to the second range.

Clause 57. The laser device of clause 55, wherein: the micro-pulse width is constrained to a first preferred range of 1 to 3 milliseconds; the macro-pulse width is constrained to a second preferred range of 15 to 25 milliseconds; and the control circuitry is configured to, after receiving the particular micro-pulse width and the particular macro-pulse width and before causing the laser source to emit the QPW laser beam: limit the particular micro-pulse width to the first preferred range; and limit the particular macro-pulse width to the second preferred range.

Clause 58. The laser device of any one of clauses 53 to 57, wherein: the one or more signals for transmission as the laser control signal further comprise a PW signal, a CW signal, or a QCW signal; the laser source is further configured to receive the laser control signal and emit a laser beam responsive to receiving the laser control signal and in accordance with the laser control signal, wherein the laser beam comprises either (i) a PW laser beam, (ii) the QPW laser beam, (iii) a CW laser beam, or (iv) a QCW laser beam; the control circuitry is further configured to, after causing the signal generator to generate the laser control signal in accordance with the requested mode: receive another user request to operate in another requested mode comprising either (i) the PW mode, (ii) the CW mode, or (iii) the QCW mode; and responsive to receiving the other user request, cause the signal generator to generate the laser control signal in accordance with the other requested mode.

Clause 59. The laser device of clause 58, wherein: the one or more signals for transmission as the laser control signal comprise at least the PW signal and the QPW signal; and an expected energy output for the QPW laser beam at a first peak-power setting is substantially equal to (e.g., within 1%, 2%, 3% of) an expected energy output for the PW laser beam at a second peak-power setting, wherein the first peak-power setting is substantially greater than (e.g., 10%, 20%, 30% greater than) the second peak-power setting.

Clause 60. The laser device of any one of clauses 53 to 59, wherein the laser beam has a wavelength between 445-465 nanometers.

Clause 61. The laser device of any one of clauses 53 to 60, further comprising: an RFID reader configured to read from and write to an RFID tag embedded within the optical waveguide, wherein the RFID tag comprises a unique identifier associated with the optical waveguide; wherein the control circuitry is further configured to: cause the RFID reader to read the unique identifier from the RFID tag; identify the optical waveguide based on the unique identifier; and write a use identifier to the RFID tag, wherein the use identifier indicates that the optical waveguide has been used in a surgical procedure.

Clause 62. The laser device of clause 61, wherein the control circuitry is further configured to: cause the RFID reader to read the use identifier from the RFID tag; determine based on the use identifier whether the optical waveguide has been used in a surgical procedure; and reject the optical waveguide responsive to determining that the optical waveguide has been used in a surgical procedure.

Clause 63. A non-transitory, computer-readable medium comprising instructions that, when executed by a processor of an electronic device comprising a signal generator and a laser source, cause the processor to: receive a user request to operate in a requested mode comprising a QPW mode; responsive to receiving the user request, cause the signal generator to generate a laser control signal in accordance with the requested mode, wherein the signal generator is configured to separately generate one or more signals for transmission as a laser control signal, and the one or more signals comprises a QPW signal; wherein the laser source is configured to receive the laser control signal and emit a QPW laser beam responsive to receiving the laser control signal; and wherein an optical waveguide is configured to emit the laser beam from a second end of the optical waveguide after receiving the laser beam at a first end of the optical waveguide.

Clause 64. The non-transitory, computer-readable medium of clause 63, wherein: the electronic device further comprises a display configured to present a user interface; and the instructions further cause the processor to: responsive to receiving the user request to operate in the requested mode being the QPW mode, cause the display to present, via the user interface, parameters for the QPW laser beam; receive user adjustments to the parameters for the QPW laser beam; and while the laser source is emitting the QPW laser beam, cause the laser source to emit the QPW laser beam according to the user adjustments to the parameters for the QPW laser beam.

Clause 65. The non-transitory, computer-readable medium of clause 64, wherein: the parameters for the QPW laser beam comprise a micro-pulse width for the QPW laser beam and a macro-pulse width for the QPW laser beam; receiving the user adjustments to the parameters comprises receiving a particular micro-pulse width and a particular macro-pulse width; and causing the laser source to emit the QPW laser beam according to the user adjustments comprises causing the laser source to emit the QPW laser beam with the particular micro-pulse width and the particular macro-pulse width.

Clause 66. The non-transitory, computer-readable medium of clause 65, wherein: the micro-pulse width is constrained to a first range of 1 to 3 milliseconds; the macro-pulse width is constrained to a second range of 10 to 30 milliseconds; and the instructions further cause the processor to, after receiving the particular micro-pulse width and the particular macro-pulse width and before causing the laser source to emit the QPW laser beam: limit the particular micro-pulse width to the first range; and limit the particular macro-pulse width to the second range.

Clause 67. The non-transitory, computer-readable medium of clause 65, wherein: the micro-pulse width is constrained to a first range of 1.5 to 2.5 milliseconds; the macro-pulse width is constrained to a second range of 15 to 25 milliseconds; and the instructions further cause the processor to, after receiving the particular micro-pulse width and the particular macro-pulse width and before causing the laser source to emit the QPW laser beam: limit the particular micro-pulse width to the first range; and limit the particular macro-pulse width to the second range.

Clause 68. The non-transitory, computer-readable medium of any one of clauses 63 to 67, wherein: the one or more signals for transmission as the laser control signal further comprise a PW signal, a CW signal, or a QCW signal; the laser source is further configured to receive the laser control signal and emit a laser beam responsive to receiving the laser control signal and in accordance with the laser control signal, wherein the laser beam comprises either (i) a PW laser beam, (ii) the QPW laser beam, (iii) a CW laser beam, or (iv) a QCW laser beam; the instructions further cause the processor to, after causing the signal generator to generate the laser control signal in accordance with the requested mode: receive another user request to operate in another requested mode comprising either (i) the PW mode, (ii) the CW mode, or (iii) the QCW mode; and responsive to receiving the other user request, cause the signal generator to generate the laser control signal in accordance with the other requested mode.

Clause 69. The non-transitory, computer-readable medium of clause 68, wherein: the one or more signals for transmission as the laser control signal comprise at least the PW signal and the QPW signal; and an expected energy output for the QPW laser beam at a first peak-power setting is substantially equal to (e.g., within 1%, 2%, 3% of) an expected energy output for the PW laser beam at a second peak-power setting, wherein the first peak-power setting is substantially greater than (e.g., 10%, 20%, 30% greater than) the second peak-power setting.

Clause 70. The non-transitory, computer-readable medium of any one of clauses 63 to 69, wherein the laser beam has a wavelength between 445-465 nanometers.

Clause 71. The non-transitory, computer-readable medium of any one of clauses 63 to 70, wherein: the electronic device further comprises an RFID reader configured to read from and write to an RFID tag embedded within the optical waveguide, wherein the RFID tag comprises a unique identifier associated with the optical waveguide; and the instructions further cause the processor to: cause the RFID reader to read the unique identifier from the RFID tag; identify the optical waveguide based on the unique identifier; and write a use identifier to the RFID tag, wherein the use identifier indicates that the optical waveguide has been used in a surgical procedure.

Clause 72. The non-transitory, computer-readable medium of clause 71, wherein the instructions further cause the processor to: cause the RFID reader to read the use identifier from the RFID tag; determine based on the use identifier whether the optical waveguide has been used in a surgical procedure; and reject the optical waveguide responsive to determining that the optical waveguide has been used in a surgical procedure.

Clause 73. A method of performing laser surgery, comprising: causing a laser device to emit a QPW laser beam; and while the laser device is emitting the QPW laser beam, simultaneously (i) directing the laser device toward target tissue and (ii) positioning the laser device within a region of clinical effectiveness (e.g., region 614) determined at least in part by a peak-power setting of the laser device.

Clause 74. The method of clause 73, wherein: the peak-power setting of the laser device is approximately 30 watts-peak; and the region of clinical effectiveness is defined by upper and lower bounds (sec, e.g., intersections of line 726 and bounds 730, 728) of approximately 4 and 2.4 millimeters from the target tissue, respectively.

Clause 75. The method of clause 73 or 74, wherein: the laser device comprises a display configured to present a user interface for adjusting parameters for the QPW laser beam; and the method further comprises adjusting one or more of the parameters for the QPW laser beam via the user interface, wherein adjusting the one or more parameters affects at least an upper or lower bound (see, e.g., intersections of line 726 and bounds 730, 728) of the region of clinical effectiveness.

Clause 76. The method of clause 75, wherein: the parameters for the QPW laser beam comprise a micro-pulse width for the QPW laser beam and a macro-pulse width for the QPW laser beam; adjusting the one or more parameters comprises adjusting the micro-pulse width and the macro-pulse width for the QPW laser beam, wherein the laser beam is further configured to emit the QPW laser beam in accordance with the micro-pulse width and the macro-pulse width.

Clause 77. The method of clause 76, wherein the user interface constrains adjustment of (i) the micro-pulse width to a first range of 1 to 3 milliseconds and (ii) the macro-pulse width to a second range of 10 to 30 milliseconds.

Clause 78. The method of any one of clauses 73 to 77, further comprising: causing the laser device to emit a PW, QCW, or CW laser beam; and while the laser device is emitting the PW, QCW, or CW laser beam, simultaneously (i) directing the laser device toward the target tissue and (ii) positioning the laser device within another region of clinical effectiveness determined at least in part by the peak-power setting of the laser device, wherein the other region of clinical effectiveness is smaller than the region of clinical effectiveness for the QPW laser beam.

Clause 79. The method of clause 77 or 78, wherein: the laser device is configured to emit at least the QPW and PW laser beams; and an expected energy output for the QPW laser beam at a first peak-power setting is within 5% of an expected energy output for the PW laser beam at a second peak-power setting, wherein the first peak-power setting is at least 5% higher than the second peak-power setting.

Clause 80. The method of any one of clauses 73 to 79, wherein the laser beam has a wavelength between 445-465 nanometers.

Clause 81. The method of any one of clauses 73 to 80, wherein: the laser device further comprises an RFID reader configured to read from and write to an RFID tag embedded within an optical waveguide for emitting the QPW laser beam, wherein the RFID tag comprises a unique identifier associated with the optical waveguide; and the laser device is further configured to: cause the RFID reader to read the unique identifier from the RFID tag; identify the optical waveguide based on the unique identifier; and write a use identifier to the RFID tag, wherein the use identifier indicates that the optical waveguide has been used in a surgical procedure.

Further Consideration. The specific order or hierarchy of steps in the processes disclosed herein is an illustration of example approaches. Based upon design preferences, it is understood that the specific order or hierarchy of steps in the processes may be rearranged. Some of the steps may be performed simultaneously. The accompanying method claims pre-sent elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not in-tended to be limited to the aspects shown herein, but is to be accorded the full scope consistent with the language claims, wherein reference to an element in the singular is not intend-ed to mean “one and only one” unless specifically so stated, but rather “one or more.” Unless specifically stated otherwise, the term “some” refers to one or more. Headings and subheadings, if any, are used for convenience only and do not limit the invention described herein.

The predicate words “configured to,” “operable to,” and “programmed to” do not imply any particular tangible or intangible modification of a subject, but rather are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as “implementations” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

As used herein, the terms “determine” and “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

As used herein, the term “message” encompasses a wide variety of formats for communicating (e.g., transmitting or receiving) information. A message may include a machine readable aggregation of information such as an XML document, fixed field message, comma separated message, JSON, a custom protocol, or the like. A message may, in some embodiments, include a signal utilized to transmit one or more representations of the information. While recited in the singular, it will be appreciated that a message may be composed, transmitted, stored, received, and so on in multiple parts.

As used herein, the term “selectively” or “selective” may encompass a wide variety of actions. For example, a “selective” process may include determining one option from multiple options. A “selective” process may include one or more of: dynamically determined in-puts, preconfigured inputs, or user-initiated inputs for making the determination. In some embodiments, an n-input switch may be included to provide selective functionality where n is the number of inputs used to make the selection.

As used herein, the terms “correspond” or “corresponding” encompasses a structural, functional, quantitative and/or qualitative correlation or relationship between two or more objects, data sets, information and/or the like, preferably where the correspondence or relationship may be used to translate one or more of the two or more objects, data sets, information and/or the like so to appear to be the same or equal. Correspondence may be assessed using one or more of a threshold, a value range, fuzzy logic, pattern matching, a machine-learning assessment model, or combinations thereof.

In any embodiment, data generated or detected can be forwarded to a “remote” device or location, where “remote,” means a location or device other than the location or device at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

What is claimed is:

1. A laser device comprising:
a signal generator configured to separately generate one or more signals for transmission as a laser control signal, wherein the one or more signals comprises a QPW signal;
a laser source configured to receive the laser control signal and emit a QPW laser beam responsive to receiving the laser control signal;
a display configured to present a user interface; and
control circuitry configured to:
receive a user request to operate in a requested mode comprising a QPW mode;
responsive to receiving the user request, cause the signal generator to generate the laser control signal in accordance with the requested mode;
responsive to receiving the user request, cause the display to present, via the user interface, a micro-pulse width for the QPW laser beam and a macro-pulse width for the QPW laser beam;
receive a particular micro-pulse width and a particular macro-pulse width;
limit the particular micro-pulse width to a first preferred range of 1.5 to 2.5 milliseconds, wherein the micro-pulse width is constrained to the first preferred range;
limit the particular macro-pulse width to a second preferred range of 15 to 25 milliseconds, wherein the macro-pulse width is constrained to the second preferred range; and
while the laser source is emitting the QPW laser beam, cause the laser source to emit the QPW laser beam with the particular micro-pulse width and the particular macro-pulse width;
wherein an optical waveguide is configured to emit the QPW laser beam from a second end of the optical waveguide after receiving the laser beam at a first end of the optical waveguide.

2. A laser device comprising:
a signal generator configured to separately generate one or more signals for transmission as a laser control signal, wherein the one or more signals comprises a QPW signal;
a laser source configured to receive the laser control signal and emit a QPW laser beam responsive to receiving the laser control signal; and
control circuitry configured to:
receive a user request to operate in a requested mode comprising a QPW mode; and
responsive to receiving the user request, cause the signal generator to generate the laser control signal in accordance with the requested mode;
wherein an optical waveguide is configured to emit the laser beam from a second end of the optical waveguide after receiving the laser beam at a first end of the optical waveguide.

3. The laser device of claim 2, further comprising a display configured to present a user interface, wherein the control circuitry is further configured to:
responsive to receiving the user request to operate in the requested mode being the QPW mode, cause the display to present, via the user interface, parameters for the QPW laser beam;
receive user adjustments to the parameters for the QPW laser beam; and
while the laser source is emitting the QPW laser beam, cause the laser source to emit the QPW laser beam according to the user adjustments to the parameters for the QPW laser beam.

4. The laser device of claim 3, wherein:
the parameters for the QPW laser beam comprise a micro-pulse width for the QPW laser beam and a macro-pulse width for the QPW laser beam;
receiving the user adjustments to the parameters comprises receiving a particular micro-pulse width and a particular macro-pulse width; and
causing the laser source to emit the QPW laser beam according to the user adjustments comprises causing the laser source to emit the QPW laser beam with the particular micro-pulse width and the particular macro-pulse width.

5. The laser device of claim 4, wherein:
the micro-pulse width is constrained to a first range of 1 to 3 milliseconds;
the macro-pulse width is constrained to a second range of 10 to 30 milliseconds; and
the control circuitry is configured to, after receiving the particular micro-pulse width and the particular macro-pulse width and before causing the laser source to emit the QPW laser beam:
limit the particular micro-pulse width to the first range; and
limit the particular macro-pulse width to the second range.

6. The laser device of claim 4, wherein:
the micro-pulse width is constrained to a first preferred range of 1.5 to 2.5 milliseconds;
the macro-pulse width is constrained to a second preferred range of 15 to 25 milliseconds; and
the control circuitry is configured to, after receiving the particular micro-pulse width and the particular macro-pulse width and before causing the laser source to emit the QPW laser beam:
limit the particular micro-pulse width to the first preferred range; and
limit the particular macro-pulse width to the second preferred range.

7. The laser device of claim 2, wherein:
the one or more signals for transmission as the laser control signal further comprise a PW signal, a CW signal, or a QCW signal;
the laser source is further configured to receive the laser control signal and emit a laser beam responsive to receiving the laser control signal and in accordance with the laser control signal, wherein the laser beam comprises either (i) a PW laser beam, (ii) the QPW laser beam, (iii) a CW laser beam, or (iv) a QCW laser beam;
the control circuitry is further configured to, after causing the signal generator to generate the laser control signal in accordance with the requested mode:
receive another user request to operate in another requested mode comprising either (i) a PW mode, (ii) a CW mode, or (iii) a QCW mode; and
responsive to receiving the other user request, cause the signal generator to generate the laser control signal in accordance with the other requested mode.

8. The laser device of claim 7, wherein:
the one or more signals for transmission as the laser control signal comprise at least the PW signal and the QPW signal; and
an expected energy output for the QPW laser beam at a first peak-power setting is within 5% of an expected energy output for the PW laser beam at a second peak-power setting, wherein the first peak-power setting is at least 5% higher than the second peak-power setting.

9. The laser device of claim 2, wherein the laser beam has a wavelength between 445-465 nanometers.

10. The laser device of claim 2, further comprising:
an RFID reader configured to read from and write to an RFID tag embedded within the optical waveguide, wherein the RFID tag comprises a unique identifier associated with the optical waveguide;
wherein the control circuitry is further configured to:
cause the RFID reader to read the unique identifier from the RFID tag;
identify the optical waveguide based on the unique identifier; and
write a use identifier to the RFID tag, wherein the use identifier indicates that the optical waveguide has been used in a surgical procedure.

11. The laser device of claim 10, wherein the control circuitry is further configured to:
cause the RFID reader to read the use identifier from the RFID tag;
determine based on the use identifier whether the optical waveguide has been used in a surgical procedure; and
reject the optical waveguide responsive to determining that the optical waveguide has been used in a surgical procedure.

12. A method of performing laser surgery, comprising:
causing a laser device to emit a QPW laser beam; and
while the laser device is emitting the QPW laser beam, simultaneously (i) directing the laser device toward target tissue and (ii) positioning the laser device within a region of clinical effectiveness determined at least in part by a peak-power setting of the laser device.

13. The method of claim 12, wherein:
the peak-power setting of the laser device is approximately 30 watts-peak; and
the region of clinical effectiveness is defined by upper and lower bounds of approximately 4 and 2.4 millimeters from the target tissue, respectively.

14. The method of claim 12, wherein:
the laser device comprises a display configured to present a user interface for adjusting parameters for the QPW laser beam; and
the method further comprises adjusting one or more of the parameters for the QPW laser beam via the user interface, wherein adjusting the one or more parameters affects at least an upper or lower bound of the region of clinical effectiveness.

15. The method of claim 14, wherein:
the parameters for the QPW laser beam comprise a micro-pulse width for the QPW laser beam and a macro-pulse width for the QPW laser beam;
adjusting the one or more parameters comprises adjusting the micro-pulse width and the macro-pulse width for the QPW laser beam, wherein the laser beam is further configured to emit the QPW laser beam in accordance with the micro-pulse width and the macro-pulse width.

16. The method of claim 15, wherein the user interface constrains adjustment of (i) the micro-pulse width to a first range of 1 to 3 milliseconds and (ii) the macro-pulse width to a second range of 10 to 30 milliseconds.

17. The method of claim 12, further comprising:
causing the laser device to emit a PW, QCW, or CW laser beam; and
while the laser device is emitting the PW, QCW, or CW laser beam, simultaneously (i) directing the laser device toward the target tissue and (ii) positioning the laser device within another region of clinical effectiveness determined at least in part by the peak-power setting of the laser device, wherein the other region of clinical effectiveness is smaller than the region of clinical effectiveness for the QPW laser beam.

18. The method of claim 16, wherein:
the laser device is configured to emit at least the QPW and PW laser beams; and
an expected energy output for the QPW laser beam at a first peak-power setting is within 5% of an expected energy output for the PW laser beam at a second peak-power setting, wherein the first peak-power setting is at least 5% higher than the second peak-power setting.

19. The method of claim 12, wherein the laser beam has a wavelength between 445-465 nanometers.

20. The method of claim 12, wherein:
the laser device further comprises an RFID reader configured to read from and write to an RFID tag embedded within an optical waveguide for emitting the QPW laser beam, wherein the RFID tag comprises a unique identifier associated with the optical waveguide; and
the laser device is further configured to:
cause the RFID reader to read the unique identifier from the RFID tag;
identify the optical waveguide based on the unique identifier; and
write a use identifier to the RFID tag, wherein the use identifier indicates that the optical waveguide has been used in a surgical procedure.
